(19) United States
(12) Patent Application Publication
(10) Pub. No.: US 2016/0026912 A1
(43) Pub. Date: Jan. 28, 2016

(54) WEIGHT-SHIFTING MECHANISM FOR CONVOLUTIONAL NEURAL NETWORKS

(71) Applicant: Intel Corporation, Santa Clara, CA (US)

(72) Inventors: Ayose J. Falcon, L'Hospitalet de Llobregat (ES); Marc Lupon, Barcelona (ES); Enric Herrero Abellanas, Cardedeu (ES); Pedro Lopez, Molins de Rei (ES); Fernando Latorre, Barcelona (ES); Frederico C. Pratas, Barcelona (ES); Georgios Tournavitis, Barcelona (ES)

(21) Appl. No.: 14/337,979

(22) Filed: Jul. 22, 2014

(51) Int. Cl. G06N 3/06; G06N 3/08

(52) U.S. Cl. CPC G06N 3/06; G06N 3/08

(57) ABSTRACT

A processor includes a processor core and a calculation circuit. The processor core includes logic determine a set of weights for use in a convolutional neural network (CNN) calculation and scale up the weights using a scale value. The calculation circuit includes logic to receive the scale value, the set of weights, and a set of input values, wherein each input value and associated weight of a same fixed size. The calculation circuit also includes logic to determine results from convolutional neural network (CNN) calculations based upon the set of weights applied to the set of input values, scale down the results using the scale value, truncate the scaled down results to the fixed size, and communicatively couple the truncated results to an output for a layer of the CNN.

### FIELD OF THE INVENTION

The present disclosure pertains to the field of processing logic, microprocessors, and associated instruction set architecture that, when executed by the processor or other processing logic, perform logical, mathematical, or other functional operations.

### DESCRIPTION OF RELATED ART

Multiprocessor systems are becoming more and more common. Applications of multiprocessor systems include dynamic domain partitioning all the way down to desktop computing. In order to take advantage of multiprocessor systems, code to be executed may be separated into multiple threads for execution by various processing entities. Each thread may be executed in parallel with one another.

Choosing cryptographic routines may include choosing trade-offs between security and resources necessary to implement the routine. While some cryptographic routines are not as secure as others, the resources necessary to implement them may be small enough to enable their use in a variety of applications where computing resources, such as processing power and memory, are less available than, for example, a desktop computer or larger computing scheme. The cost of implementing routines such as cryptographic routines may be measured in gate counts or gate-equivalent counts, throughput, power consumption, or production cost. Several cryptographic routines for use in computing applications include those known as AES, Hight, Iceberg, Katan, Klein, Led, mCrypton, Piccolo, Present, Prince, Twine, and EPCBC, though these routines are not necessarily compatible with each other, nor may one routine necessarily substitute for another.

Convolutional Neural Network (CNN) is a computational model, recently gaining popularity due to its power in solving human-computer interface problems such as image understanding. The core of the model is a multi-staged algorithm that takes, as input, a large range of inputs (e.g., image pixels) and applies a set of transformations to the inputs in accordance to predefined functions. The transformed data may be fed into a neural network to detect patterns.

### DESCRIPTION OF THE FIGURES

Embodiments are illustrated by way of example and not limitation in the Figures of the accompanying drawings:

FIG. 1A is a block diagram of an exemplary computer system formed with a processor that may include execution units to execute an instruction, in accordance with embodiments of the present disclosure;

FIG. 1B illustrates a data processing system, in accordance with embodiments of the present disclosure;

FIG. 1C illustrates other embodiments of a data processing system for performing text string comparison operations;

FIG. 2 is a block diagram of the micro-architecture for a processor that may include logic circuits to perform instructions, in accordance with embodiments of the present disclosure;

FIG. 3A is a block diagram of a processor, in accordance with embodiments of the present disclosure;

FIG. 3B is a block diagram of an example implementation of a core, in accordance with embodiments of the present disclosure;

FIG. 4 is a block diagram of a system, in accordance with embodiments of the present disclosure;

FIG. 5 is a block diagram of a second system, in accordance with embodiments of the present disclosure;

FIG. 6 is a block diagram of a third system in accordance with embodiments of the present disclosure;

FIG. 7 is a block diagram of a system-on-a-chip, in accordance with embodiments of the present disclosure;

FIG. 8 is a block diagram of an electronic device for utilizing a processor, in accordance with embodiments of the present disclosure;

FIG. 9 illustrates an example embodiment of a neural network system, in accordance with embodiments of the present disclosure.

FIG. 10 illustrates a more detailed embodiment for implementing a neural network system using a processing device, in accordance with embodiments of the present disclosure.

FIG. 11 is a more detailed illustration of processing device to perform calculation for different layers of a neural network system, in accordance with embodiments of the present disclosure.

FIG. 12 illustrates an example embodiment of a calculation circuit, in accordance with embodiments of the present disclosure.

FIGS. 13A, 13B, and 13C are more detailed illustrations of various components of a calculation circuit.

FIG. 14 is a flowchart of an example embodiment of a method for weight-shifting, in accordance with embodiments of the present disclosure.

### DETAILED DESCRIPTION

The following description describes weight-shifting mechanism for reconfigurable processing units within or in association with a processor, virtual processor, package, computer system, or other processing apparatus. In one embodiment, such a weight-shifting mechanism may be used in convolution neural networks (CNN). In another embodiment, such CNNs may include low-precision CNNs. In the following description, numerous specific details such as processing logic, processor types, micro-architectural conditions, events, enablement mechanisms, and the like are set forth in order to provide a more thorough understanding of embodiments of the present disclosure. It will be appreciated, however, by one skilled in the art that the embodiments may be practiced without such specific details. Additionally, some well-known structures, circuits, and the like have not been shown in detail to avoid unnecessarily obscuring embodiments of the present disclosure.

Although the following embodiments are described with reference to a processor, other embodiments are applicable to other types of integrated circuits and logic devices. Similar techniques and teachings of embodiments of the present disclosure may be applied to other types of circuits or semiconductor devices that may benefit from higher pipeline throughput and improved performance. The teachings of embodiments of the present disclosure are applicable to any processor or machine that performs data manipulations. However, the embodiments are not limited to processors or machines that perform 512-bit, 256-bit, 128-bit, 64-bit, 32-bit, 16-bit, or 8-bit data operations and may be applied to any processor and machine in which manipulation or management of data may be performed. In addition, the following description provides examples, and the accompanying drawings show various examples for the purposes of illustration. However, these examples should not be construed in a limiting sense as they are merely intended to provide examples of embodiments of the present disclosure rather than to provide an exhaustive list of all possible implementations of embodiments of the present disclosure.

Although the below examples describe instruction handling and distribution in the context of execution units and logic circuits, other embodiments of the present disclosure may be accomplished by way of a data or instructions stored on a machine-readable, tangible medium, which when performed by a machine cause the machine to perform functions consistent with at least one embodiment of the disclosure. In one embodiment, functions associated with embodiments of the present disclosure are embodied in machine-executable instructions. The instructions may be used to cause a general-purpose or special-purpose processor that may be programmed with the instructions to perform the steps of the present disclosure. Embodiments of the present disclosure may be provided as a computer program product or software which may include a machine or computer-readable medium having stored thereon instructions which may be used to program a computer (or other electronic devices) to perform one or more operations according to embodiments of the present disclosure. Furthermore, steps of embodiments of the present disclosure might be performed by specific hardware components that contain fixed-function logic for performing the steps, or by any combination of programmed computer components and fixed-function hardware components.

Instructions used to program logic to perform embodiments of the present disclosure may be stored within a memory in the system, such as DRAM, cache, flash memory, or other storage. Furthermore, the instructions may be distributed via a network or by way of other computer-readable media. Thus a machine-readable medium may include any mechanism for storing or transmitting information in a form readable by a machine (e.g., a computer), but is not limited to, floppy diskettes, optical disks, Compact Discs, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium may include any type of tangible machine-readable medium suitable for storing or transmitting electronic instructions or information in a form readable by a machine (e.g., a computer).

A design may go through various stages, from creation to simulation to fabrication. Data representing a design may represent the design in a number of manners. First, as may be useful in simulations, the hardware may be represented using a hardware description language or another functional description language. Additionally, a circuit level model with logic and/or transistor gates may be produced at some stages of the design process. Furthermore, designs, at some stage, may reach a level of data representing the physical placement of various devices in the hardware model. In cases wherein some semiconductor fabrication techniques are used, the data representing the hardware model may be the data specifying the presence or absence of various features on different mask layers for masks used to produce the integrated circuit. In any representation of the design, the data may be stored in any form of a machine-readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or retransmission of the electrical signal is performed, a new copy may be made. Thus, a communication provider or a network provider may store on a tangible, machine-readable medium, at least temporarily, an article, such as information encoded into a carrier wave, embodying techniques of embodiments of the present disclosure.

In modern processors, a number of different execution units may be used to process and execute a variety of code and instructions. Some instructions may be quicker to complete while others may take a number of clock cycles to complete. The faster the throughput of instructions, the better the overall performance of the processor. Thus it would be advantageous to have as many instructions execute as fast as possible. However, there may be certain instructions that have greater complexity and require more in terms of execution time and processor resources, such as floating point instructions, load/store operations, data moves, etc.

As more computer systems are used in internet, text, and multimedia applications, additional processor support has been introduced over time. In one embodiment, an instruction set may be associated with one or more computer architectures, including data types, instructions, register architecture, addressing modes, memory architecture, interrupt and exception handling, and external input and output (I/O).

In one embodiment, the instruction set architecture (ISA) may be implemented by one or more micro-architectures, which may include processor logic and circuits used to implement one or more instruction sets. Accordingly, processors with different micro-architectures may share at least a portion of a common instruction set. For example, Intel® Pentium 4 processors, Intel® Core™ processors, and processors from Advanced Micro Devices, Inc. of Sunnyvale Calif. implement nearly identical versions of the x86 instruction set (with some extensions that have been added with newer versions), but have different internal designs. Similarly, processors designed by other processor development companies, such as ARM Holdings, Ltd., MIPS, or their licensees or adopters, may share at least a portion of a common instruction set, but may include different processor designs. For example, the same register architecture of the ISA may be implemented in different ways in different micro-architectures using new or well-known techniques, including dedicated physical registers, one or more dynamically allocated physical registers using a register renaming mechanism (e.g., the use of a Register Alias Table (RAT)), a Reorder Buffer (ROB) and a retirement register file. In one embodiment, registers may include one or more registers, register architectures, register files, or other register sets that may or may not be addressable by a software programmer.

An instruction may include one or more instruction formats. In one embodiment, an instruction format may indicate various fields (number of bits, location of bits, etc.) to specify, among other things, the operation to be performed and the operands on which that operation will be performed. In a further embodiment, some instruction formats may be further defined by instruction templates (or sub-formats). For example, the instruction templates of a given instruction format may be defined to have different subsets of the instruction format's fields and/or defined to have a given field interpreted differently. In one embodiment, an instruction may be expressed using an instruction format (and, if defined, in a given one of the instruction templates of that instruction format) and specifies or indicates the operation and the operands upon which the operation will operate.

Scientific, financial, auto-vectorized general purpose, RMS (recognition, mining, and synthesis), and visual and multimedia applications (e.g., 2D/3D graphics, image processing, video compression/decompression, voice recognition algorithms and audio manipulation) may require the same operation to be performed on a large number of data items. In one embodiment, Single Instruction Multiple Data (SIMD) refers to a type of instruction that causes a processor to perform an operation on multiple data elements. SIMD technology may be used in processors that may logically divide the bits in a register into a number of fixed-sized or variable-sized data elements, each of which represents a separate value. For example, in one embodiment, the bits in a 64-bit register may be organized as a source operand containing four separate 16-bit data elements, each of which represents a separate 16-bit value. This type of data may be referred to as ‘packed’ data type or ‘vector’ data type, and operands of this data type may be referred to as packed data operands or vector operands. In one embodiment, a packed data item or vector may be a sequence of packed data elements stored within a single register, and a packed data operand or a vector operand may a source or destination operand of a SIMD instruction (or ‘packed data instruction’ or a ‘vector instruction’). In one embodiment, a SIMD instruction specifies a single vector operation to be performed on two source vector operands to generate a destination vector operand (also referred to as a result vector operand) of the same or different size, with the same or different number of data elements, and in the same or different data element order.

SIMD technology, such as that employed by the Intel® Core™ processors having an instruction set including x86, MMX™, Streaming SIMD Extensions (SSE), SSE2, SSE3, SSE4.1, and SSE4.2 instructions, ARM processors, such as the ARM Cortex® family of processors having an instruction set including the Vector Floating Point (VFP) and/or NEON instructions, and MIPS processors, such as the Loongson family of processors developed by the Institute of Computing Technology (ICT) of the Chinese Academy of Sciences, has enabled a significant improvement in application performance (Core™ and MMX™ are registered trademarks or trademarks of Intel Corporation of Santa Clara, Calif.).

In one embodiment, destination and source registers/data may be generic terms to represent the source and destination of the corresponding data or operation. In some embodiments, they may be implemented by registers, memory, or other storage areas having other names or functions than those depicted. For example, in one embodiment, “DEST1” may be a temporary storage register or other storage area, whereas “SRC1” and “SRC2” may be a first and second source storage register or other storage area, and so forth. In other embodiments, two or more of the SRC and DEST storage areas may correspond to different data storage elements within the same storage area (e.g., a SIMD register). In one embodiment, one of the source registers may also act as a destination register by, for example, writing back the result of an operation performed on the first and second source data to one of the two source registers serving as a destination registers.

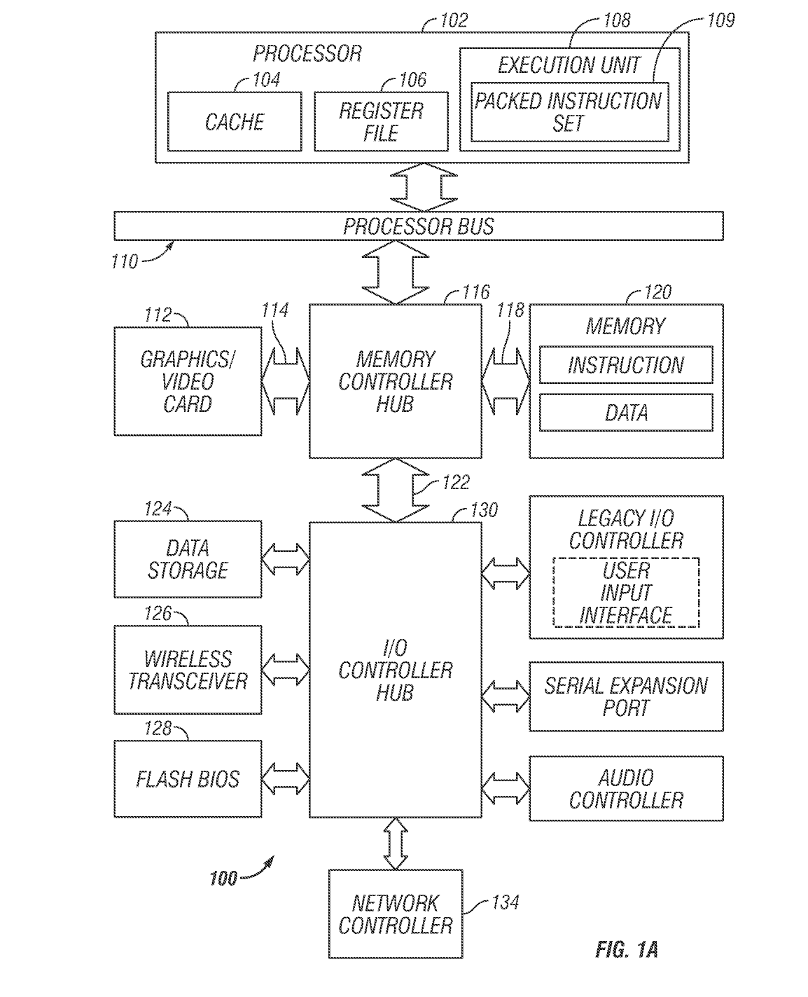

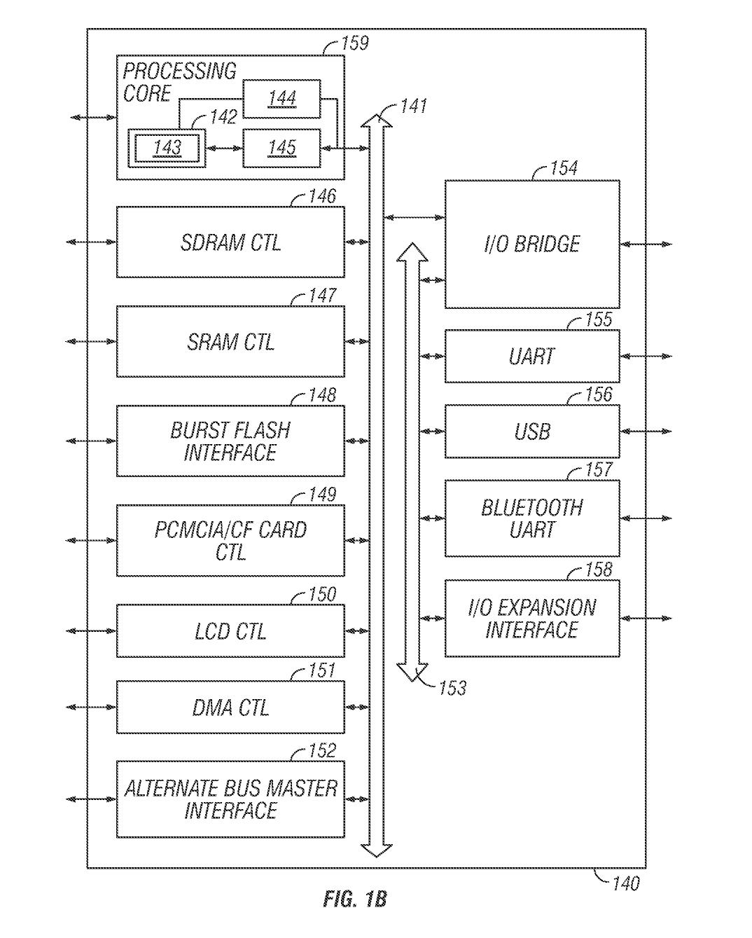

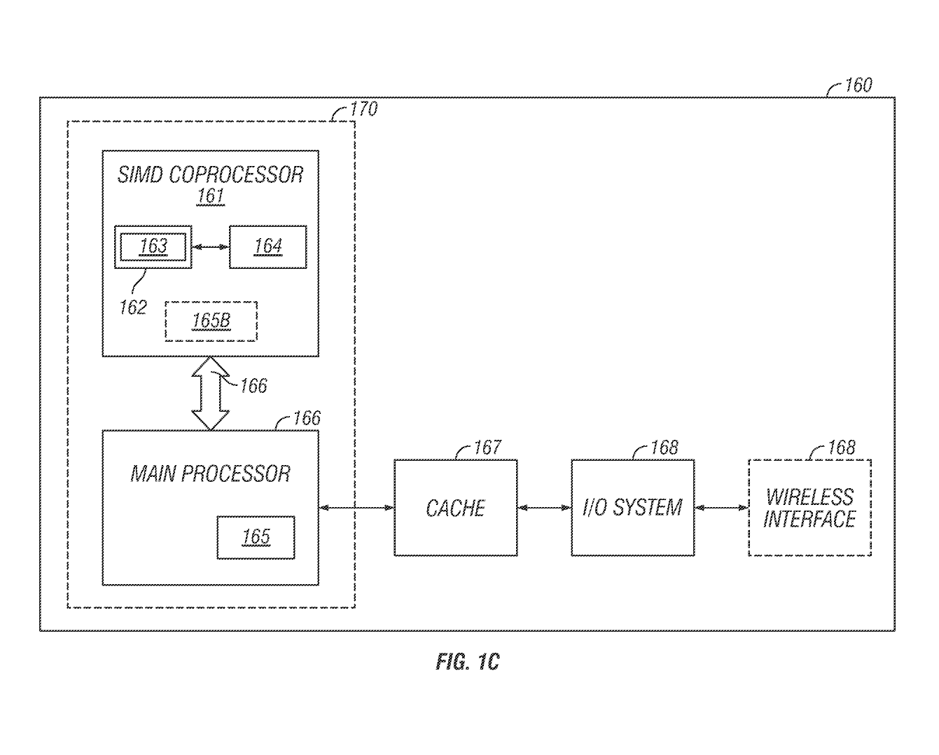

FIG. 1A is a block diagram of an exemplary computer system formed with a processor that may include execution units to execute an instruction, in accordance with embodiments of the present disclosure. System 100 may include a component, such as a processor 102 to employ execution units including logic to perform algorithms for process data, in accordance with the present disclosure, such as in the embodiment described herein. System 100 may be representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 100 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present disclosure are not limited to any specific combination of hardware circuitry and software.

Embodiments are not limited to computer systems. Embodiments of the present disclosure may be used in other devices such as handheld devices and embedded applications. Some examples of handheld devices include cellular phones, Internet Protocol devices, digital cameras, personal digital assistants (PDAs), and handheld PCs. Embedded applications may include a micro controller, a digital signal processor (DSP), system on a chip, network computers (NetPC), set-top boxes, network hubs, wide area network (WAN) switches, or any other system that may perform one or more instructions in accordance with at least one embodiment.

Computer system 100 may include a processor 102 that may include one or more execution units 108 to perform an algorithm to perform at least one instruction in accordance with one embodiment of the present disclosure. One embodiment may be described in the context of a single processor desktop or server system, but other embodiments may be included in a multiprocessor system. System 100 may be an example of a ‘hub’ system architecture. System 100 may include a processor 102 for processing data signals. Processor 102 may include a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. In one embodiment, processor 102 may be coupled to a processor bus 110 that may transmit data signals between processor 102 and other components in system 100. The elements of system 100 may perform conventional functions that are well known to those familiar with the art.

In one embodiment, processor 102 may include a Level 1 (L1) internal cache memory 104. Depending on the architecture, the processor 102 may have a single internal cache or multiple levels of internal cache. In another embodiment, the cache memory may reside external to processor 102. Other embodiments may also include a combination of both internal and external caches depending on the particular implementation and needs. Register file 106 may store different types of data in various registers including integer registers, floating point registers, status registers, and instruction pointer register.

Execution unit 108, including logic to perform integer and floating point operations, also resides in processor 102. Processor 102 may also include a microcode (ucode) ROM that stores microcode for certain macroinstructions. In one embodiment, execution unit 108 may include logic to handle a packed instruction set 109. By including the packed instruction set 109 in the instruction set of a general-purpose processor 102, along with associated circuitry to execute the instructions, the operations used by many multimedia applications may be performed using packed data in a general-purpose processor 102. Thus, many multimedia applications may be accelerated and executed more efficiently by using the full width of a processor's data bus for performing operations on packed data. This may eliminate the need to transfer smaller units of data across the processor's data bus to perform one or more operations one data element at a time.

Embodiments of an execution unit 108 may also be used in micro controllers, embedded processors, graphics devices, DSPs, and other types of logic circuits. System 100 may include a memory 120. Memory 120 may be implemented as a Dynamic Random Access Memory (DRAM) device, a Static Random Access Memory (SRAM) device, flash memory device, or other memory device. Memory 120 may store instructions and/or data represented by data signals that may be executed by processor 102.

A system logic chip 116 may be coupled to processor bus 110 and memory 120. System logic chip 116 may include a memory controller hub (MCH). Processor 102 may communicate with MCH 116 via a processor bus 110. MCH 116 may provide a high bandwidth memory path 118 to memory 120 for instruction and data storage and for storage of graphics commands, data and textures. MCH 116 may direct data signals between processor 102, memory 120, and other components in system 100 and to bridge the data signals between processor bus 110, memory 120, and system I/O 122. In some embodiments, the system logic chip 116 may provide a graphics port for coupling to a graphics controller 112. MCH 116 may be coupled to memory 120 through a memory interface 118. Graphics card 112 may be coupled to MCH 116 through an Accelerated Graphics Port (AGP) interconnect 114.

System 100 may use a proprietary hub interface bus 122 to couple MCH 116 to I/O controller hub (ICH) 130. In one embodiment, ICH 130 may provide direct connections to some I/O devices via a local I/O bus. The local I/O bus may include a high-speed I/O bus for connecting peripherals to memory 120, chipset, and processor 102. Examples may include the audio controller, firmware hub (flash BIOS) 128, wireless transceiver 126, data storage 124, legacy I/O controller containing user input and keyboard interfaces, a serial expansion port such as Universal Serial Bus (USB), and a network controller 134. Data storage device 124 may comprise a hard disk drive, a floppy disk drive, a CD-ROM device, a flash memory device, or other mass storage device.

For another embodiment of a system, an instruction in accordance with one embodiment may be used with a system on a chip. One embodiment of a system on a chip comprises of a processor and a memory. The memory for one such system may include a flash memory. The flash memory may be located on the same die as the processor and other system components. Additionally, other logic blocks such as a memory controller or graphics controller may also be located on a system on a chip.

FIG. 1B illustrates a data processing system 140 which implements the principles of embodiments of the present disclosure. It will be readily appreciated by one of skill in the art that the embodiments described herein may operate with alternative processing systems without departure from the scope of embodiments of the disclosure.

Computer system 140 comprises a processing core 159 for performing at least one instruction in accordance with one embodiment. In one embodiment, processing core 159 represents a processing unit of any type of architecture, including but not limited to a CISC, a RISC or a VLIW-type architecture. Processing core 159 may also be suitable for manufacture in one or more process technologies and by being represented on a machine-readable media in sufficient detail, may be suitable to facilitate said manufacture.

Processing core 159 comprises an execution unit 142, a set of register files 145, and a decoder 144. Processing core 159 may also include additional circuitry (not shown) which may be unnecessary to the understanding of embodiments of the present disclosure. Execution unit 142 may execute instructions received by processing core 159. In addition to performing typical processor instructions, execution unit 142 may perform instructions in packed instruction set 143 for performing operations on packed data formats. Packed instruction set 143 may include instructions for performing embodiments of the disclosure and other packed instructions. Execution unit 142 may be coupled to register file 145 by an internal bus. Register file 145 may represent a storage area on processing core 159 for storing information, including data. As previously mentioned, it is understood that the storage area may store the packed data might not be critical. Execution unit 142 may be coupled to decoder 144. Decoder 144 may decode instructions received by processing core 159 into control signals and/or microcode entry points. In response to these control signals and/or microcode entry points, execution unit 142 performs the appropriate operations. In one embodiment, the decoder may interpret the opcode of the instruction, which will indicate what operation should be performed on the corresponding data indicated within the instruction.

Processing core 159 may be coupled with bus 141 for communicating with various other system devices, which may include but are not limited to, for example, Synchronous Dynamic Random Access Memory (SDRAM) control 146, Static Random Access Memory (SRAM) control 147, burst flash memory interface 148, Personal Computer Memory Card International Association (PCMCIA)/Compact Flash (CF) card control 149, Liquid Crystal Display (LCD) control 150, Direct Memory Access (DMA) controller 151, and alternative bus master interface 152. In one embodiment, data processing system 140 may also comprise an I/O bridge 154 for communicating with various I/O devices via an I/O bus 153. Such I/O devices may include but are not limited to, for example, Universal Asynchronous Receiver/Transmitter (UART) 155, Universal Serial Bus (USB) 156, Bluetooth wireless UART 157 and I/O expansion interface 158.

One embodiment of data processing system 140 provides for mobile, network and/or wireless communications and a processing core 159 that may perform SIMD operations including a text string comparison operation. Processing core 159 may be programmed with various audio, video, imaging and communications algorithms including discrete transformations such as a Walsh-Hadamard transform, a fast Fourier transform (FFT), a discrete cosine transform (DCT), and their respective inverse transforms; compression/decompression techniques such as color space transformation, video encode motion estimation or video decode motion compensation; and modulation/demodulation (MODEM) functions such as pulse coded modulation (PCM).

FIG. 1C illustrates other embodiments of a data processing system that performs SIMD text string comparison operations. In one embodiment, data processing system 160 may include a main processor 166, a SIMD coprocessor 161, a cache memory 167, and an input/output system 168. Input/output system 168 may optionally be coupled to a wireless interface 169. SIMD coprocessor 161 may perform operations including instructions in accordance with one embodiment. In one embodiment, processing core 170 may be suitable for manufacture in one or more process technologies and by being represented on a machine-readable media in sufficient detail, may be suitable to facilitate the manufacture of all or part of data processing system 160 including processing core 170.

In one embodiment, SIMD coprocessor 161 comprises an execution unit 162 and a set of register files 164. One embodiment of main processor 165 comprises a decoder 165 to recognize instructions of instruction set 163 including instructions in accordance with one embodiment for execution by execution unit 162. In other embodiments, SIMD coprocessor 161 also comprises at least part of decoder 165 to decode instructions of instruction set 163. Processing core 170 may also include additional circuitry (not shown) which may be unnecessary to the understanding of embodiments of the present disclosure.

In operation, main processor 166 executes a stream of data processing instructions that control data processing operations of a general type including interactions with cache memory 167, and input/output system 168. Embedded within the stream of data processing instructions may be SIMD coprocessor instructions. Decoder 165 of main processor 166 recognizes these SIMD coprocessor instructions as being of a type that should be executed by an attached SIMD coprocessor 161. Accordingly, main processor 166 issues these SIMD coprocessor instructions (or control signals representing SIMD coprocessor instructions) on the coprocessor bus 166. From coprocessor bus 166, these instructions may be received by any attached SIMD coprocessors. In this case, SIMD coprocessor 161 may accept and execute any received SIMD coprocessor instructions intended for it.

Data may be received via wireless interface 169 for processing by the SIMD coprocessor instructions. For one example, voice communication may be received in the form of a digital signal, which may be processed by the SIMD coprocessor instructions to regenerate digital audio samples representative of the voice communications. For another example, compressed audio and/or video may be received in the form of a digital bit stream, which may be processed by the SIMD coprocessor instructions to regenerate digital audio samples and/or motion video frames. In one embodiment of processing core 170, main processor 166, and a SIMD coprocessor 161 may be integrated into a single processing core 170 comprising an execution unit 162, a set of register files 164, and a decoder 165 to recognize instructions of instruction set 163 including instructions in accordance with one embodiment.

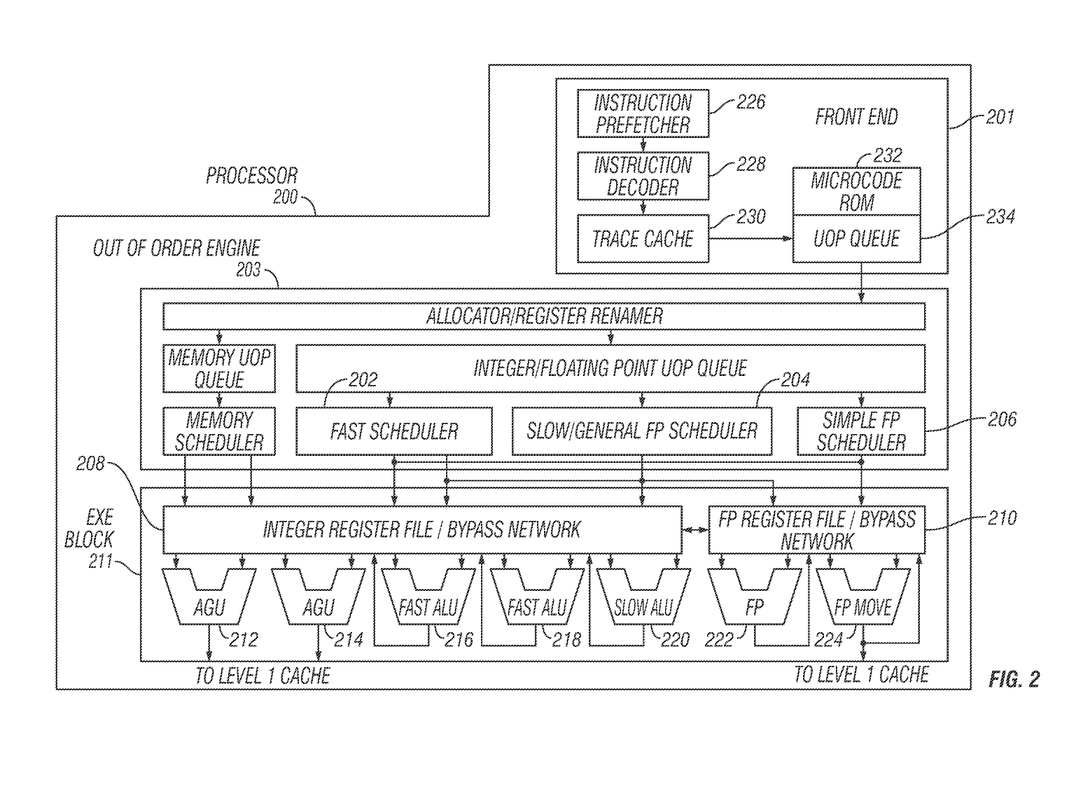

FIG. 2 is a block diagram of the micro-architecture for a processor 200 that may include logic circuits to perform instructions, in accordance with embodiments of the present disclosure. In some embodiments, an instruction in accordance with one embodiment may be implemented to operate on data elements having sizes of byte, word, doubleword, quadword, etc., as well as datatypes, such as single and double precision integer and floating point datatypes. In one embodiment, in-order front end 201 may implement a part of processor 200 that may fetch instructions to be executed and prepares the instructions to be used later in the processor pipeline. Front end 201 may include several units. In one embodiment, instruction prefetcher 226 fetches instructions from memory and feeds the instructions to an instruction decoder 228 which in turn decodes or interprets the instructions. For example, in one embodiment, the decoder decodes a received instruction into one or more operations called “micro-instructions” or “micro-operations” (also called micro op or uops) that the machine may execute. In other embodiments, the decoder parses the instruction into an opcode and corresponding data and control fields that may be used by the micro-architecture to perform operations in accordance with one embodiment. In one embodiment, trace cache 230 may assemble decoded uops into program ordered sequences or traces in uop queue 234 for execution. When trace cache 230 encounters a complex instruction, microcode ROM 232 provides the uops needed to complete the operation.

Some instructions may be converted into a single micro-op, whereas others need several micro-ops to complete the full operation. In one embodiment, if more than four micro-ops are needed to complete an instruction, decoder 228 may access microcode ROM 232 to perform the instruction. In one embodiment, an instruction may be decoded into a small number of micro-ops for processing at instruction decoder 228. In another embodiment, an instruction may be stored within microcode ROM 232 should a number of micro-ops be needed to accomplish the operation. Trace cache 230 refers to an entry point programmable logic array (PLA) to determine a correct micro-instruction pointer for reading the micro-code sequences to complete one or more instructions in accordance with one embodiment from micro-code ROM 232. After microcode ROM 232 finishes sequencing micro-ops for an instruction, front end 201 of the machine may resume fetching micro-ops from trace cache 230.

Out-of-order execution engine 203 may prepare instructions for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 202, slow/general floating point scheduler 204, and simple floating point scheduler 206. Uop schedulers 202, 204, 206, determine when a uop is ready to execute based on the readiness of their dependent input register operand sources and the availability of the execution resources the uops need to complete their operation. Fast scheduler 202 of one embodiment may schedule on each half of the main clock cycle while the other schedulers may only schedule once per main processor clock cycle. The schedulers arbitrate for the dispatch ports to schedule uops for execution.

Register files 208, 210 may be arranged between schedulers 202, 204, 206, and execution units 212, 214, 216, 218, 220, 222, 224 in execution block 211. Each of register files 208, 210 perform integer and floating point operations, respectively. Each register file 208, 210, may include a bypass network that may bypass or forward just completed results that have not yet been written into the register file to new dependent uops. Integer register file 208 and floating point register file 210 may communicate data with the other. In one embodiment, integer register file 208 may be split into two separate register files, one register file for low-order thirty-two bits of data and a second register file for high order thirty-two bits of data. Floating point register file 210 may include 128-bit wide entries because floating point instructions typically have operands from 64 to 128 bits in width.

Execution block 211 may contain execution units 212, 214, 216, 218, 220, 222, 224. Execution units 212, 214, 216, 218, 220, 222, 224 may execute the instructions. Execution block 211 may include register files 208, 210 that store the integer and floating point data operand values that the micro-instructions need to execute. In one embodiment, processor 200 may comprise a number of execution units: address generation unit (AGU) 212, AGU 214, fast Arithmetic Logic Unit (ALU) 216, fast ALU 218, slow ALU 220, floating point ALU 222, floating point move unit 224. In another embodiment, floating point execution blocks 222, 224, may execute floating point, MMX, SIMD, and SSE, or other operations. In yet another embodiment, floating point ALU 222 may include a 64-bit by 64-bit floating point divider to execute divide, square root, and remainder micro-ops. In various embodiments, instructions involving a floating point value may be handled with the floating point hardware. In one embodiment, ALU operations may be passed to high-speed ALU execution units 216, 218. High-speed ALUs 216, 218 may execute fast operations with an effective latency of half a clock cycle. In one embodiment, most complex integer operations go to slow ALU 220 as slow ALU 220 may include integer execution hardware for long-latency type of operations, such as a multiplier, shifts, flag logic, and branch processing. Memory load/store operations may be executed by AGUs 212, 214. In one embodiment, integer ALUs 216, 218, 220 may perform integer operations on 64-bit data operands. In other embodiments, ALUs 216, 218, 220 may be implemented to support a variety of data bit sizes including sixteen, thirty-two, 128, 256, etc. Similarly, floating point units 222, 224 may be implemented to support a range of operands having bits of various widths. In one embodiment, floating point units 222, 224, may operate on 128-bit wide packed data operands in conjunction with SIMD and multimedia instructions.

In one embodiment, uops schedulers 202, 204, 206, dispatch dependent operations before the parent load has finished executing. As uops may be speculatively scheduled and executed in processor 200, processor 200 may also include logic to handle memory misses. If a data load misses in the data cache, there may be dependent operations in flight in the pipeline that have left the scheduler with temporarily incorrect data. A replay mechanism tracks and re-executes instructions that use incorrect data. Only the dependent operations might need to be replayed and the independent ones may be allowed to complete. The schedulers and replay mechanism of one embodiment of a processor may also be designed to catch instruction sequences for text string comparison operations.

The term “registers” may refer to the on-board processor storage locations that may be used as part of instructions to identify operands. In other words, registers may be those that may be usable from the outside of the processor (from a programmer's perspective). However, in some embodiments registers might not be limited to a particular type of circuit. Rather, a register may store data, provide data, and perform the functions described herein. The registers described herein may be implemented by circuitry within a processor using any number of different techniques, such as dedicated physical registers, dynamically allocated physical registers using register renaming, combinations of dedicated and dynamically allocated physical registers, etc. In one embodiment, integer registers store 32-bit integer data. A register file of one embodiment also contains eight multimedia SIMD registers for packed data. For the discussions below, the registers may be understood to be data registers designed to hold packed data, such as 64-bit wide MMX™ registers (also referred to as ‘mm’ registers in some instances) in microprocessors enabled with MMX technology from Intel Corporation of Santa Clara, Calif. These MMX registers, available in both integer and floating point forms, may operate with packed data elements that accompany SIMD and SSE instructions. Similarly, 128-bit wide XMM registers relating to SSE2, SSE3, SSE4, or beyond (referred to generically as “SSEx”) technology may hold such packed data operands. In one embodiment, in storing packed data and integer data, the registers do not need to differentiate between the two data types. In one embodiment, integer and floating point may be contained in the same register file or different register files. Furthermore, in one embodiment, floating point and integer data may be stored in different registers or the same registers.

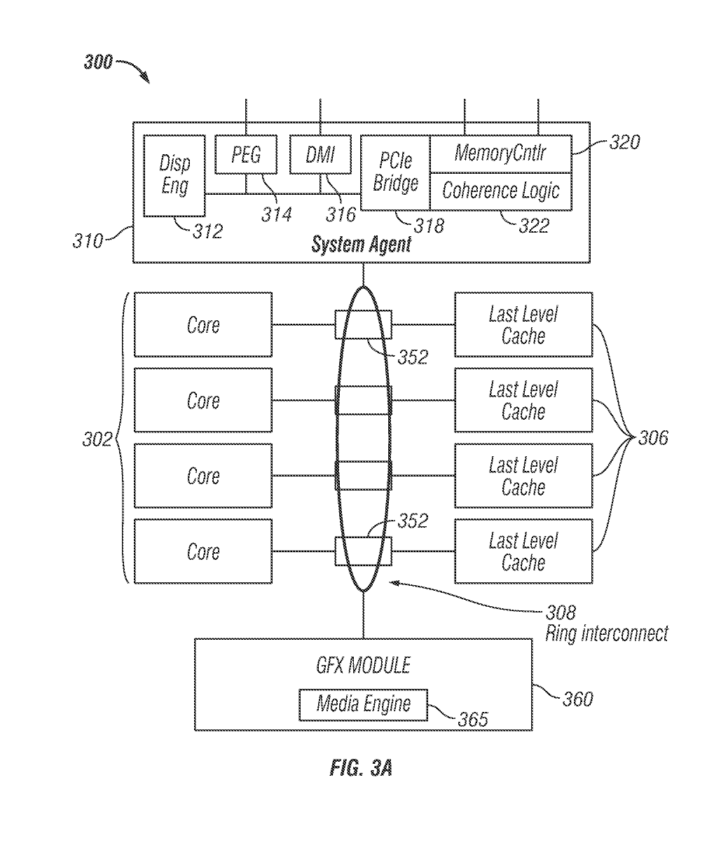

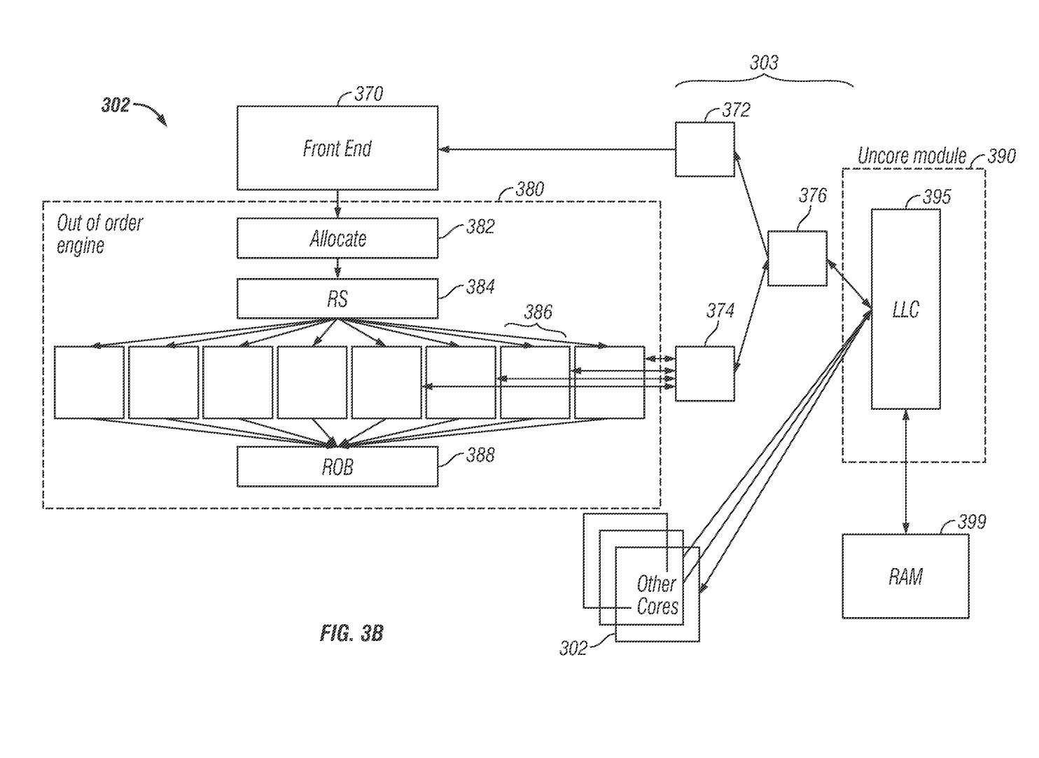

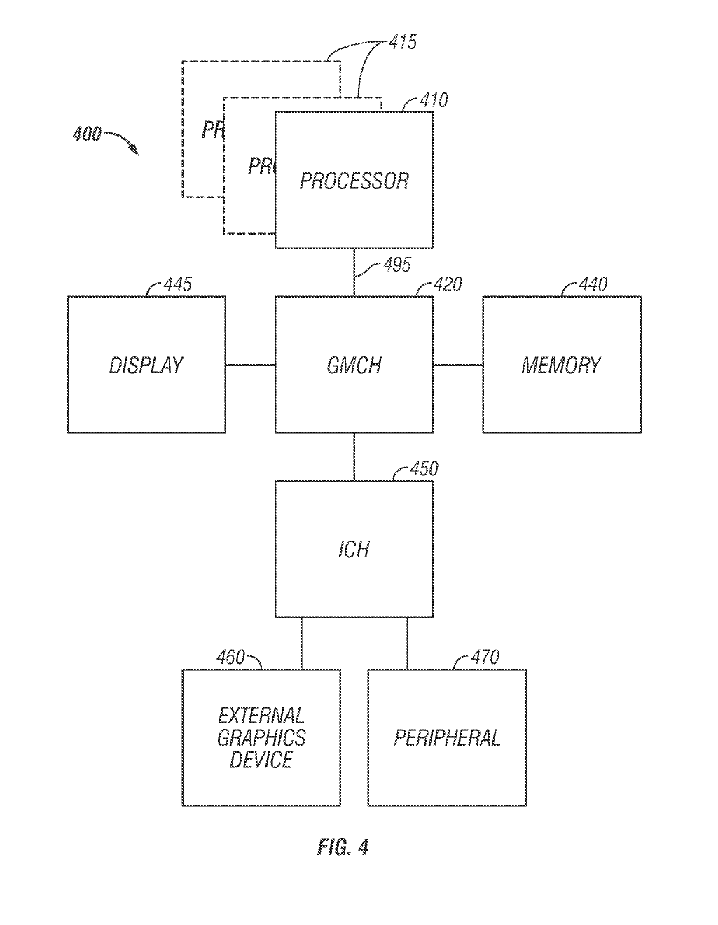

FIGS. 3-5 may illustrate exemplary systems suitable for including processor 300, while FIG. 4 may illustrate an exemplary System on a Chip (SoC) that may include one or more of cores 302. Other system designs and implementations known in the arts for laptops, desktops, handheld PCs, personal digital assistants, engineering workstations, servers, network devices, network hubs, switches, embedded processors, DSPs, graphics devices, video game devices, set-top boxes, micro controllers, cell phones, portable media players, hand held devices, and various other electronic devices, may also be suitable. In general, a huge variety of systems or electronic devices that incorporate a processor and/or other execution logic as disclosed herein may be generally suitable.

FIG. 4 illustrates a block diagram of a system 400, in accordance with embodiments of the present disclosure. System 400 may include one or more processors 410, 415, which may be coupled to Graphics Memory Controller Hub (GMCH) 420. The optional nature of additional processors 415 is denoted in FIG. 4 with broken lines.

Each processor 410, 415 may be some version of processor 300. However, it should be noted that integrated graphics logic and integrated memory control units might not exist in processors 410, 415. FIG. 4 illustrates that GMCH 420 may be coupled to a memory 440 that may be, for example, a dynamic random access memory (DRAM). The DRAM may, for at least one embodiment, be associated with a non-volatile cache.

GMCH 420 may be a chipset, or a portion of a chipset. GMCH 420 may communicate with processors 410, 415 and control interaction between processors 410, 415 and memory 440. GMCH 420 may also act as an accelerated bus interface between the processors 410, 415 and other elements of system 400. In one embodiment, GMCH 420 communicates with processors 410, 415 via a multi-drop bus, such as a frontside bus (FSB) 495.

Furthermore, GMCH 420 may be coupled to a display 445 (such as a flat panel display). In one embodiment, GMCH 420 may include an integrated graphics accelerator. GMCH 420 may be further coupled to an input/output (I/O) controller hub (ICH) 450, which may be used to couple various peripheral devices to system 400. External graphics device 460 may include be a discrete graphics device coupled to ICH 450 along with another peripheral device 470.

In other embodiments, additional or different processors may also be present in system 400. For example, additional processors 410, 415 may include additional processors that may be the same as processor 410, additional processors that may be heterogeneous or asymmetric to processor 410, accelerators (such as, e.g., graphics accelerators or digital signal processing (DSP) units), field programmable gate arrays, or any other processor. There may be a variety of differences between the physical resources 410, 415 in terms of a spectrum of metrics of merit including architectural, micro-architectural, thermal, power consumption characteristics, and the like. These differences may effectively manifest themselves as asymmetry and heterogeneity amongst processors 410, 415. For at least one embodiment, various processors 410, 415 may reside in the same die package.

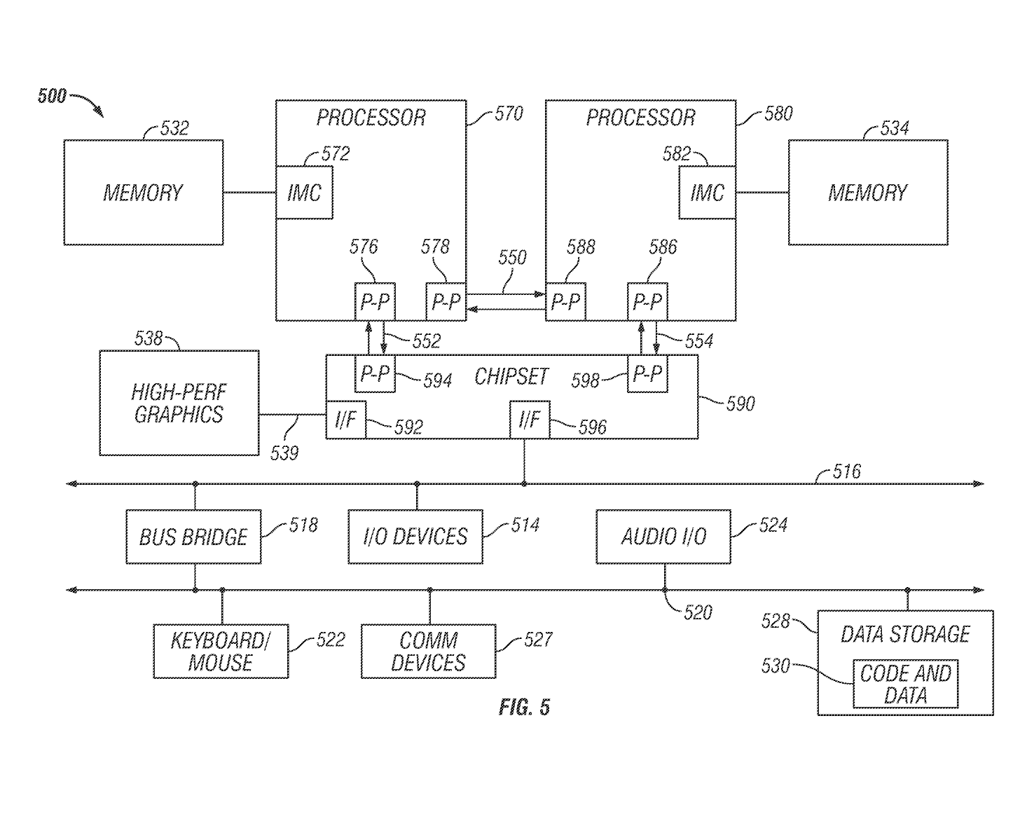

FIG. 5 illustrates a block diagram of a second system 500, in accordance with embodiments of the present disclosure. As shown in FIG. 5, multiprocessor system 500 may include a point-to-point interconnect system, and may include a first processor 570 and a second processor 580 coupled via a point-to-point interconnect 550. Each of processors 570 and 580 may be some version of processor 300 as one or more of processors 410,615.

While FIG. 5 may illustrate two processors 570, 580, it is to be understood that the scope of the present disclosure is not so limited. In other embodiments, one or more additional processors may be present in a given processor.

Processors 570 and 580 are shown including integrated memory controller units 572 and 582, respectively. Processor 570 may also include as part of its bus controller units point-to-point (P-P) interfaces 576 and 578; similarly, second processor 580 may include P-P interfaces 586 and 588. Processors 570, 580 may exchange information via a point-to-point (P-P) interface 550 using P-P interface circuits 578, 588. As shown in FIG. 5, IMCs 572 and 582 may couple the processors to respective memories, namely a memory 532 and a memory 534, which in one embodiment may be portions of main memory locally attached to the respective processors.

Processors 570, 580 may each exchange information with a chipset 590 via individual P-P interfaces 552, 554 using point to point interface circuits 576, 594, 586, 598. In one embodiment, chipset 590 may also exchange information with a high-performance graphics circuit 538 via a high-performance graphics interface 539.

A shared cache (not shown) may be included in either processor or outside of both processors, yet connected with the processors via P-P interconnect, such that either or both processors' local cache information may be stored in the shared cache if a processor is placed into a low power mode.

Chipset 590 may be coupled to a first bus 516 via an interface 596. In one embodiment, first bus 516 may be a Peripheral Component Interconnect (PCI) bus, or a bus such as a PCI Express bus or another third generation I/O interconnect bus, although the scope of the present disclosure is not so limited.

As shown in FIG. 5, various I/O devices 514 may be coupled to first bus 516, along with a bus bridge 518 which couples first bus 516 to a second bus 520. In one embodiment, second bus 520 may be a Low Pin Count (LPC) bus. Various devices may be coupled to second bus 520 including, for example, a keyboard and/or mouse 522, communication devices 527 and a storage unit 528 such as a disk drive or other mass storage device which may include instructions/code and data 530, in one embodiment. Further, an audio I/O 524 may be coupled to second bus 520. Note that other architectures may be possible. For example, instead of the point-to-point architecture of FIG. 5, a system may implement a multi-drop bus or other such architecture.

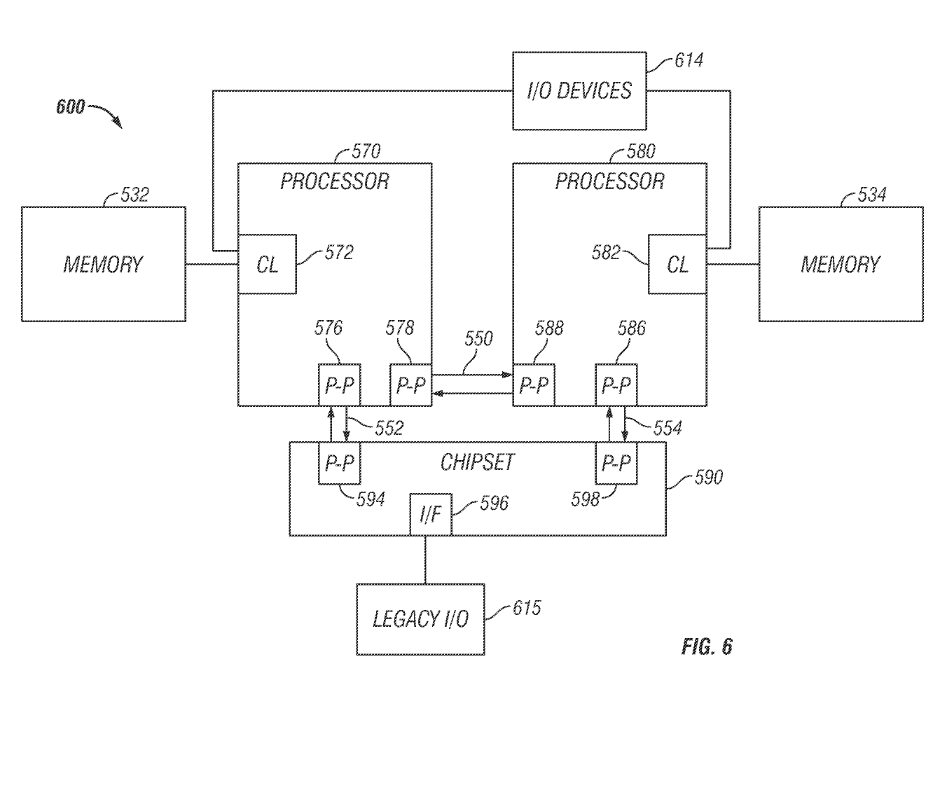

FIG. 6 illustrates a block diagram of a third system 600 in accordance with embodiments of the present disclosure. Like elements in FIGS. 5 and 6 bear like reference numerals, and certain aspects of FIG. 5 have been omitted from FIG. 6 in order to avoid obscuring other aspects of FIG. 6.

FIG. 6 illustrates that processors 670, 680 may include integrated memory and I/O Control Logic (“CL”) 672 and 682, respectively. For at least one embodiment, CL 672, 682 may include integrated memory controller units such as that described above in connection with FIGS. 3-5. In addition. CL 672, 682 may also include I/O control logic. FIG. 6 illustrates that not only memories 632, 634 may be coupled to CL 672, 682, but also that I/O devices 614 may also be coupled to control logic 672, 682. Legacy I/O devices 615 may be coupled to chipset 690.

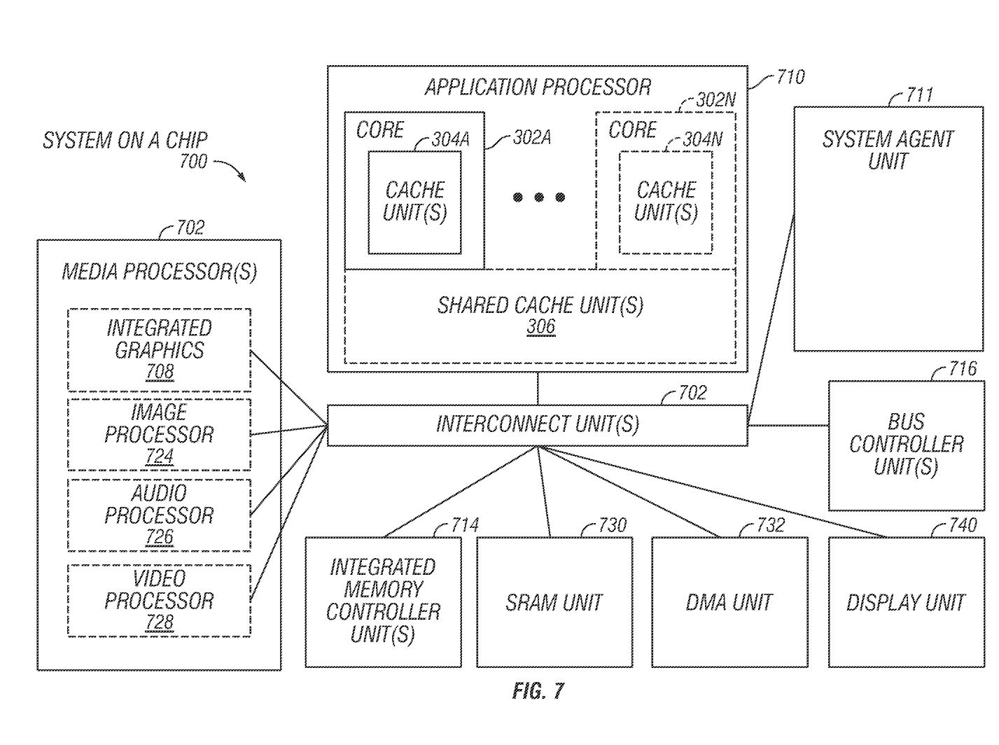

FIG. 7 illustrates a block diagram of a SoC 700, in accordance with embodiments of the present disclosure. Similar elements in FIG. 3 bear like reference numerals. Also, dashed lined boxes may represent optional features on more advanced SoCs. An interconnect units 702 may be coupled to: an application processor 710 which may include a set of one or more cores 702A-N and shared cache units 706; a system agent unit 711; a bus controller units 716; an integrated memory controller units 714; a set or one or more media processors 720 which may include integrated graphics logic 708, an image processor 724 for providing still and/or video camera functionality, an audio processor 726 for providing hardware audio acceleration, and a video processor 728 for providing video encode/decode acceleration; an SRAM unit 730; a DMA unit 732; and a display unit 740 for coupling to one or more external displays.

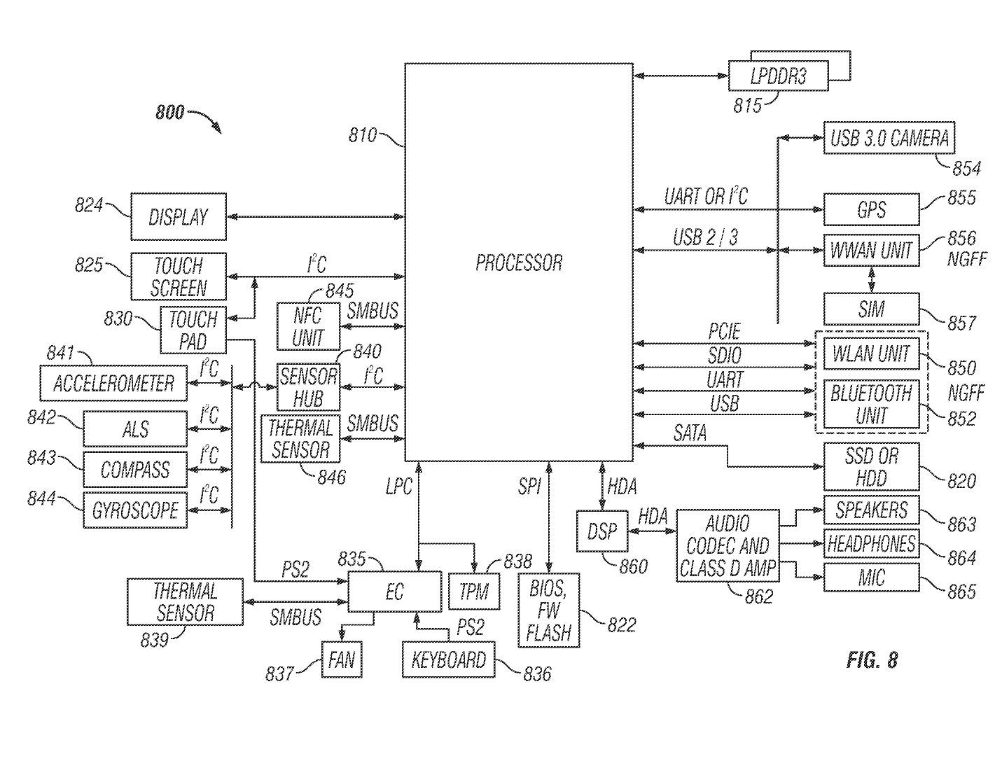

FIG. 8 is a block diagram of an electronic device 800 for utilizing a processor 810, in accordance with embodiments of the present disclosure. Electronic device 800 may include, for example, a notebook, an ultrabook, a computer, a tower server, a rack server, a blade server, a laptop, a desktop, a tablet, a mobile device, a phone, an embedded computer, or any other suitable electronic device.

Electronic device 800 may include processor 810 communicatively coupled to any suitable number or kind of components, peripherals, modules, or devices. Such coupling may be accomplished by any suitable kind of bus or interface, such as I²C bus, System Management Bus (SMBus), Low Pin Count (LPC) bus, SPI, High Definition Audio (HDA) bus, Serial Advance Technology Attachment (SATA) bus, USB bus (versions 1, 2, 3), or Universal Asynchronous Receiver/Transmitter (UART) bus.

Such components may include, for example, a display 824, a touch screen 825, a touch pad 830, a Near Field Communications (NFC) unit 845, a sensor hub 840, a thermal sensor 846, an Express Chipset (EC) 835, a Trusted Platform Module (TPM) 838, BIOS/firmware/flash memory 822, a DSP 860, a drive 820 such as a Solid State Disk (SSD) or a Hard Disk Drive (HDD), a wireless local area network (WLAN) unit 850, a Bluetooth unit 852, a Wireless Wide Area Network (WWAN) unit 856, a Global Positioning System (GPS), a camera 854 such as a USB 3.0 camera, or a Low Power Double Data Rate (LPDDR) memory unit 815 implemented in, for example, the LPDDR3 standard. These components may each be implemented in any suitable manner.

Furthermore, in various embodiments other components may be communicatively coupled to processor 810 through the components discussed above. For example, an accelerometer 841, Ambient Light Sensor (ALS) 842, compass 843, and gyroscope 844 may be communicatively coupled to sensor hub 840. A thermal sensor 839, fan 837, keyboard 846, and touch pad 830 may be communicatively coupled to EC 835. Speaker 863, headphones 864, and a microphone 865 may be communicatively coupled to an audio unit 864, which may in turn be communicatively coupled to DSP 860. Audio unit 864 may include, for example, an audio codec and a class D amplifier. A SIM card 857 may be communicatively coupled to WWAN unit 856. Components such as WLAN unit 850 and Bluetooth unit 852, as well as WWAN unit 856 may be implemented in a Next Generation Form Factor (NGFF).

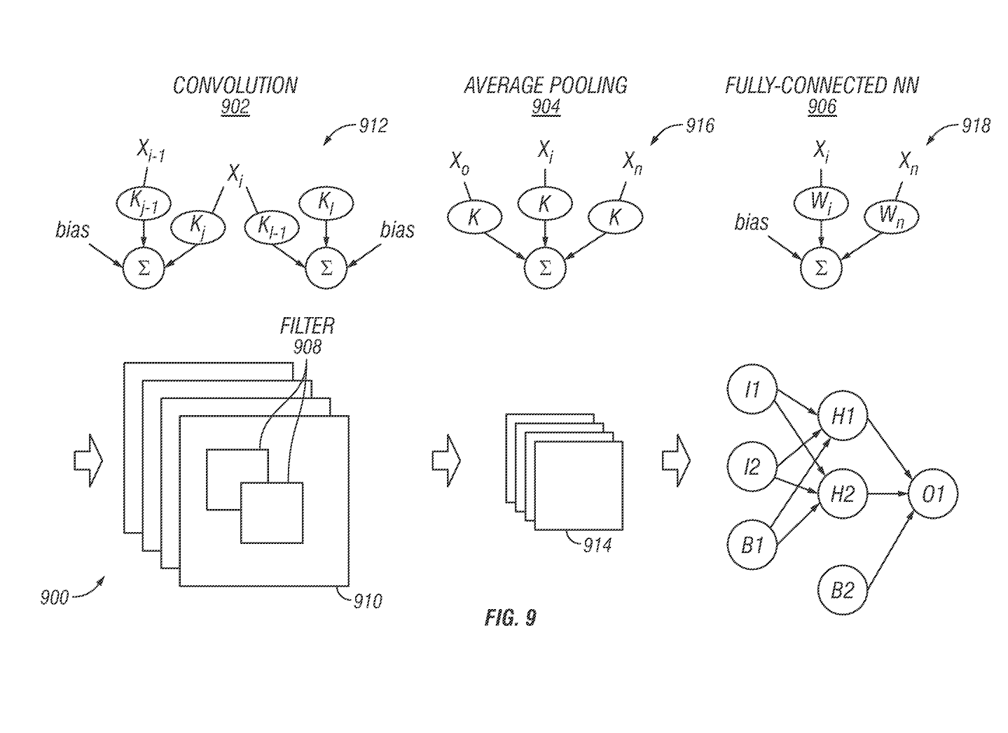

Embodiments of the present disclosure involve a weight-shifting mechanism for CNNs. In one embodiment, such mechanisms may be implemented to improve processing of CNNs. In other embodiments, such mechanisms may be applied to other reconfigurable processing units. FIG. 9 illustrates a CNN system 900 that includes a convolution layer 902, an average pooling layer 904, and a fully-connected neural network 906, in accordance with embodiments of the present disclosure. Each such may perform a unique type of operation. For example, when an input is a sequence of images 910, convolution layer 902 may apply filter operations 908 to pixels of image 910. Filter operations 908 may be implemented as convolution of a kernel over the entire image as illustratively shown in element 912, in which xᵢ₋₁, xᵢ . . . represent inputs (or pixel values), and kⱼ₋₁, kⱼ, kⱼ₊₁ represent parameters of the kernel. Results of filter operations 908 may be summed together to provide an output from convolution layer 902 to the next pooling layer 904. Pooling layer 904 may perform subsampling to reduce images 910 to a stack of reduced images 914. Subsampling operations may be achieved through average operations or maximum value computation. Element 916 of illustratively shows an average of inputs xₒ, xᵢ, xₙ. The output of pooling layer 904 may be fed to the fully-connected neural network 906 to perform pattern detections. Fully-connected neural network 906 may apply a set of weights 918 in its inputs and accumulate a result as the output of the fully-connected neural network layer 906.

In practice, convolution and pooling layers may be applied to input data multiple times prior to the results being transmitted to the fully-connected layer. Thereafter, the final output value is tested to determine whether a pattern has been recognized or not. Each of the convolution, pooling, and fully-connected neural network layers may be implemented with regular multiply-and-then-accumulate operations. Algorithms implemented on standard processors such as CPU or GPU may include integer (or fixed-point) multiplication and addition, or float-point fused multiply-add (FMA). These operations involve multiplication operations of inputs with parameters and then summation of the multiplication results. Although the multiplication and sum operations may be implemented in parallel on multi-core CPU or GPU, these implementations do not take into consideration unique requirements for different layers of CNN and thus may lead to higher bandwidth procurement, larger processing latency, and more power consumption than necessary. The circuitry of CNN systems implemented on the general purpose hardware such as general purpose CPUs or GPUs is not designed to be reconfigured according to the precision requirements of different layers, where the precision requirements are measured according to the number of bits used for calculation. To support all of the operations of different layers, current CNN systems are implemented according to the highest precision requirement at single or double floating-point precision, or at 32-bit or 16-bit fixed point precision, in the hardware units. This may lead to bandwidth, timing, and power inefficiencies.

Embodiments of the present disclosure may include modular calculation circuits that are reconfigurable according to the computational tasks. Moreover, embodiments of the present disclosure may include weight-shifting mechanisms for such circuits. In some embodiment, such weight-shifting mechanisms may be used to shift low-precision weights up and, after results are determined, scale the results back to original precision. The reconfigurable aspects of the calculation circuits may include the precision of the computation and/or the manner of the computation. Specific embodiments of the present disclosure may include modular, reconfigurable, and variable-precision calculation circuits to perform different layers of CNN. Each of the calculation circuits may include same or similarly arranged components that may be optimally adapted to different requirements of different layers of CNN systems. Thus, embodiments of the disclosure may perform filter/convolution operations for the convolution layer, average operations for the pooling layer, and dot product operations for the fully-connected layer by reusing the same calculation circuits whose precisions may be adapted for the requirements of different types of computation.

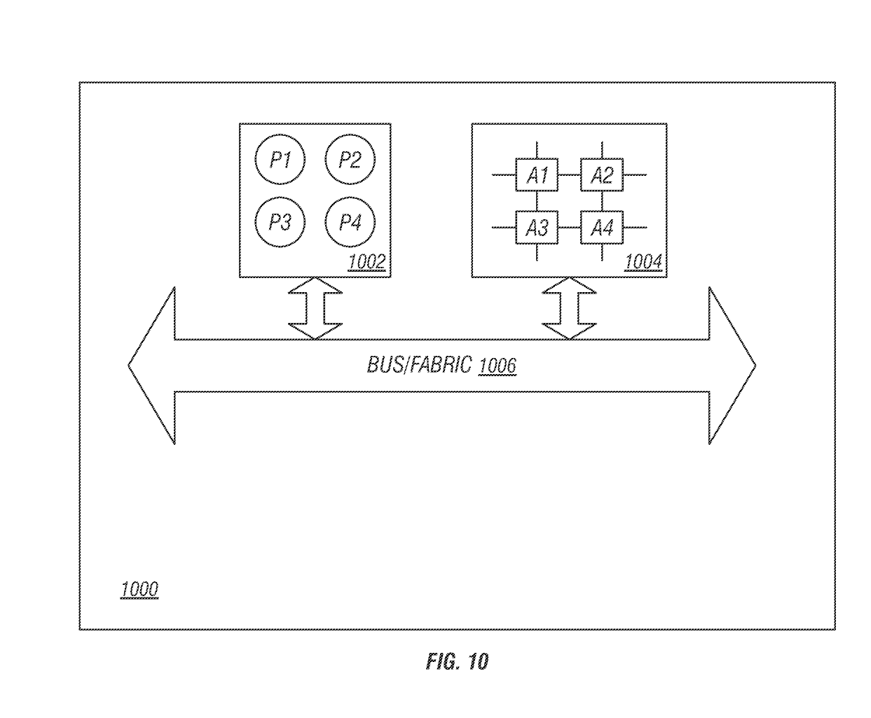

FIG. 10 illustrates a more detailed embodiment for implementing an example neural network, in accordance with embodiments of the present disclosure. In one embodiment, example CNN 900 using a weight-shifting mechanism for CNNs may be implemented using a processing device 1000. Although processing device 1000 is illustrated as implementing CNN 900, processing device 1000 may implement other neural network algorithms such as traditional neural networks or systems that only perform convolutions.

Embodiments of the present disclosure may include a processing unit implemented on, for example, a system-on-a-chip. Processing device 1000 may include a hardware processor such as a central processing unit, a graphic processing unit, or a general-purpose processing unit, or any combination thereof. Processing device 1000 may be implemented in part by, for example, the elements illustrated in FIGS. 1-8. In the example of FIG. 10, processing device 1000 may include a processor block 1002, a calculation accelerator 1004, and a bus/fabric/interconnect system 1006. Processor block 1002 may further include one or more cores (e.g., P1-P4) to perform general purpose calculations and issue control signals through bus 1006 to the calculation accelerator 1004. Calculation accelerator 1004 may further include a number of calculation circuits (e.g., A1-A4) each of which may be reconfigured to perform a specific type of calculations for a CNN system. In an embodiment, the reconfiguration may be achieved via control signals issued by processor unit 1002 and specific inputs provided to the calculation circuits. Cores within processor unit 1002 may issue, via bus 1006, control signals to calculation accelerator 1004 to control multiplexers therein so that a first set of the calculation circuits within calculation accelerator 1004 are reconfigured to perform filter operations for convolution layers at first predetermined precisions, a second set of calculation circuits are reconfigured to perform average operations for pooling layers at second predetermined precisions, and a third set of calculation circuits are reconfigured to perform the neural network computations at third precisions. In this way, processing device 1000 may be fabricated on a system-on-a-chip efficiently while the computation for CNN may be performed in a manner that optimizes resource usage. Although accelerator 1004 is illustrated as a separate circuit block from processor block 1002, in one embodiment accelerator 1004 may be fabricated as part of processor block 1002.

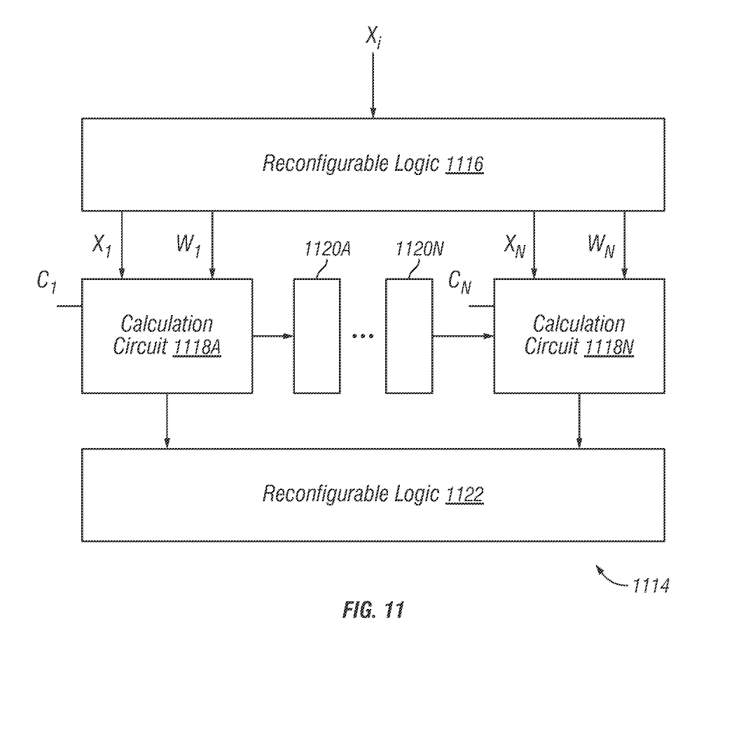

FIG. 11 is a more detailed illustration of processing device 1000, including calculation accelerator 1004, to perform calculation for different layers of CNN system 900, in accordance with embodiments of the present disclosure. FIG. 11 may illustrate aspects of an execution cluster 1114 constructed from a set of calculation circuits to multiply elements for the CNN calculations. Execution cluster 1114 may include a number of calculation circuits 1118, distribution logics 1116, 1122, and delay elements 1120. Distribution logic 1116 may receive input signal xᵢ, i=1, . . . , N, where the input signal may be image pixel values or sampled speech signals. Moreover, execution cluster 1114 may be implemented by wide multipliers, accumulators, adders, and shifters. Distribution logic 1116 may include multiplexers to transmit xᵢ to inputs of different calculation circuits 1118. Besides input signal xᵢ, distribution logic 1116 may also assign weight coefficients wᵢ, 1, . . . , N to different calculation circuits.

Calculation circuits 1118 may also receive control signals _{Ci}, i=1, . . . , N, which may be issued from processor cores, such as those in processor block 1002. Control signals _{Ci} may control multiplexers within calculation circuits 1118 to reconfigure these calculation circuits to perform filter or average operations at desirable precisions.

A copy of the output of a given one of calculation circuits 1118 may be passed to a next one of calculation circuits 1118 through one or more delay elements 1120 which may include a latch to store the output for a predetermined period of time such as one clock cycle. For example, a copy of the output of calculation circuit 1118A may be delayed by delay element 1120A before it is fed to a next calculation circuit 1118B (not shown). Another copy of outputs from calculation circuits 1118 may be weighted sum of the input xᵢ, i=1, . . . , N. When calculation circuits 1118 work collaboratively, they may achieve a convolution layer, or a pooling layer, or a fully-connected layer of a CNN system.

Calculation circuits 1118 may be implemented in any suitable manner. For example, calculation circuits 1118 may be implemented using a suitable combination of multipliers, multiplexers, delay elements, and adders. Each of calculation circuits 1118 may accept one or more input values. In one embodiment, each of calculation circuits 1118 may accept sixteen input values in parallel to achieve modular and efficient computation.

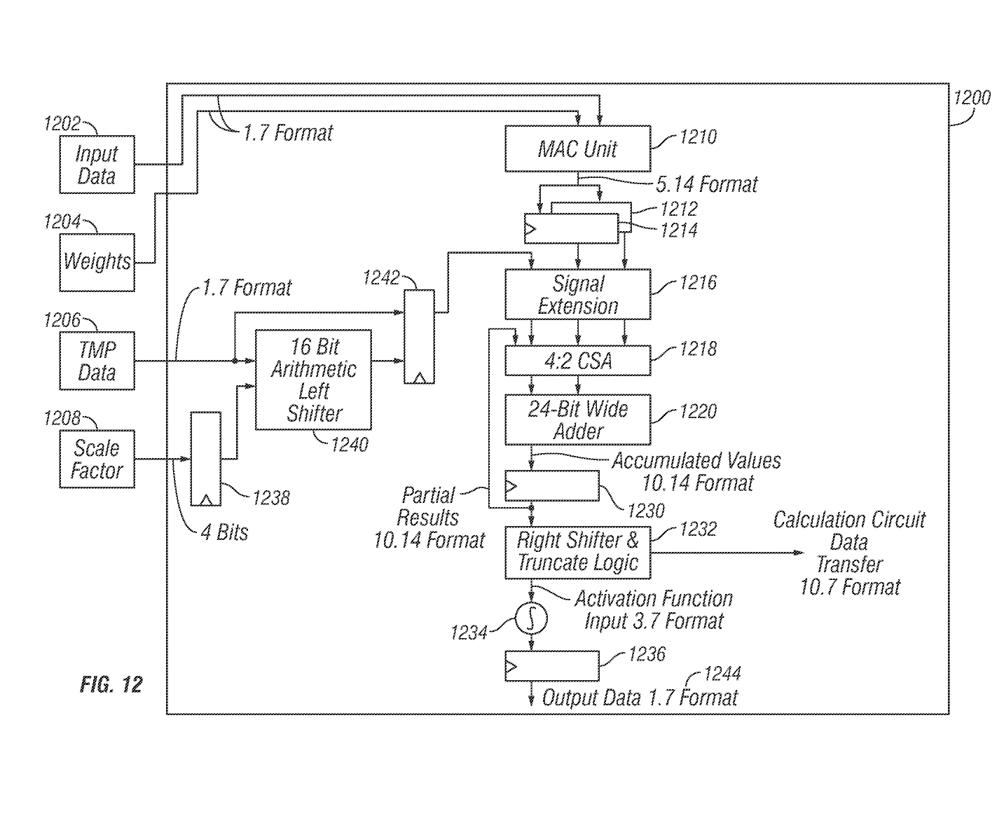

FIG. 12 illustrates an example embodiment of a calculation circuit 1200 that may be used to implement fully or in part calculation circuit 1118, in accordance with embodiments of the present disclosure. Calculation circuit 1200 may be formed from reconfigurable components. Calculation circuit 1200 may include, for example, a multiply-and-accumulate (MAC) unit 1210, a signal extension unit 1216, a 4:2 carry-save adder (CSA) 1218, a 24-bit wide adder 1220, and an activation function 1234. Furthermore, calculation circuit 1200 may include any suitable number or combination of latches to stage communication between its elements, such as latches 1212, 1214, 1230, 1236, 1238, or 1242. In one embodiment, calculation circuit 1200 may accept inputs from, for example, input data 1202 and weights 1204. In another embodiment, calculation circuit 1200 may accept inputs from temp data 1206. In yet another embodiment, calculation circuit 1200 may accept inputs from scale factor 1208. Each input may be implemented in any suitable manner, such as a latch. Weights 1204 may be implemented by, for example, weights 1118. Input data 1202 may be made by, for example, logic for dividing larger input, such as images or other data, into discrete slices. Temp data 1206 may include data received from another calculation circuit. Scale factor 1208 may include scale information used in association with such temp data 1206.

In one embodiment, calculation circuit 1200 may include a 16-bit arithmetic left shifter 1240 to scale up inputs for computations of calculation circuit 1200. In another embodiment, calculation circuit 1200 may include a right shifter and truncate logic 1232 to scale down resulting calculations of calculation circuit 1200.

Weights 1204 or input data 1202 may be low precision. In one embodiment, calculation circuit 1200 may scale weights up during calculation. Such scaling up may include increasing the numerical precision by which weights 1204 may be used. Furthermore, the degree to which weights 1204 have been scaled up may be tracked during operation of calculation circuit 1200. In another embodiment, calculation circuit 1200 may perform its calculations upon the shifted value of weights 1204 and otherwise operate within extended representation and precision. In yet another embodiment, calculation circuit 1200 may scale the result of the calculation back down to the precision used original by weights 1204. Such reverse scaling may be performed by using the tracked values by which weights 1204 were originally scaled.

Calculation circuit 1200 may perform up-scaling and down-scaling in association with convolution calculation for the CNN. The multiple layers of a neural network may be fully connected, as described above. Convolutional operation might not be fully connected. The operations included in such calculations may be all linear transformations of input data 1202.

Weights 1204 may be calculated during, for example, a learning process of the functions for the CNN. Weights 1204 may vary based on, for example, different filter functions that are available to be performed on images. Weights 1204 may be stored in memory or storage of the processor until they are needed for use by calculation circuit 1200. Input data 1202 may be read from various input layers of, for example, images.

In one embodiment, for a given layer, the maximum and minimum values of weights 1204 may be determined. In another embodiment and based on such a determination, weights 1204 may be scaled up to meet a defined range. For example, if weights 1204 are given as positive and negative fractions less than one, then weights 1204 may be scaled up to the range (−1, 1). Any suitable scaling technique may be used. In a further embodiment, such scaling may be performed by shifting functions and, accordingly, scaling by a power of two. In such an embodiment, shifting a number left may scale the number up and shifting a number right may scale the number down. In various embodiments, the scaling of weights 1204 and storing of the scale value may be performed outside calculation circuit 1204 by, for example, processing device 1000 and provided to calculation circuit 1200. Moreover, weight values used by other layers may be scaled up by, for example, 16-bit arithmetic left shifter 1240.

Once weights 1204 have been shifted, calculation circuit 1200 may store the degree to which weights 1204 have been shifted. The shifting process may emulate floating-point encoding. The original value of weights 1204 may be similar to a mantissa of floating-point operations, while the stored, scaling value may be similar to an associated exponent. In one embodiment, the scaling value of all weights 1204 may be the same during a single operation of calculation circuit 1200.

After weights 1204 have been used for calculation of convolution for the layer by calculation circuit 1200, the results may be shifted right, or scaled back down to the original precision reflected by weights 1204. In one embodiment, such shifting may be performed by right shifter and truncate logic 1232.

While calculation circuit 1200 may utilize weights 1204 at a low precision, such weights may be learned by processing device 1000 at maximum precision, such as at 32-bit floating point numbers. Weights may be scaled up for use within calculation circuit 1200 in order to maximize their possible precision. Furthermore, after weights are scaled up for use in weights 1204, weight values may be truncated in order to preserve a desired lower precision. For example, if calculation circuit 1200 is to use weights with eight bits of precision, the bottom sixteen bits may be truncated from weights before they are provided as weights 1204. Calculation circuit 1200 may utilize these, for example, eight-bit weight values to perform dot-product, convolution, or other calculations for CNN. After such calculations, calculation circuit 1200 may perform the inverse operation that was performed to scale the weights up. Specifically, calculation circuit 1200 may scale the results down using, for example, right shifter and truncate logic 1232 to scale the values back down.

Although example scaling from, for example, thirty-two-bit floating point values to eight-bit fixed point values are illustrated, scaling may be performed from any value in higher precision fixed or floating point to any lower prevision value in fixed point.

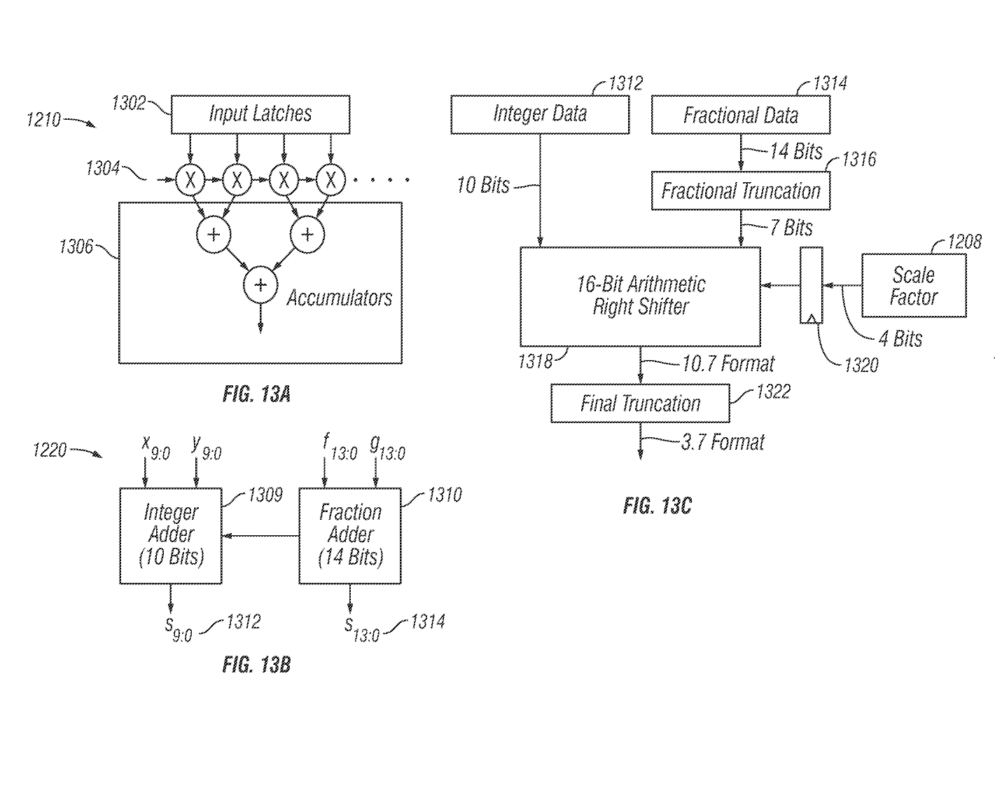

FIGS. 13A, 13B, and 13C are more detailed illustrations of various components of calculation circuit 1200, in accordance with embodiments of the present disclosure. FIG. 13A is a more detailed illustration of MAC unit 1210. Given N input values from input latches 1302, which in turn may come from input data 1202 and weights 1204, elements of input data 1202 and weights 1204 are multiplied pair-wise at 1304 and then added together in accumulators 1306. Multiplication may be made by hardware components that perform multiplication operation of integer or fixed-point inputs. In one embodiment, such multipliers may include 8-bit fixed-point multipliers. If input data 1202 and weights 1204 are each eight-bits wide (and in 1.7 format, wherein a bit is used to represent the sign and seven bits are used to represent a fractional part of a fixed-point number), then there may be sixteen pairs of inputs from input latches 1302.

Returning to FIG. 12, in one embodiment, MAC unit 1210 may output the results of convolution and dot-product operations to latches 1212, 1214. The output form may include a bit for the sign, two bits for the integer, and fourteen bits for the fractional part. This output may include partial results which may be added to other partial results from, for example, the same calculation unit 1200, another calculation unit, or memory. Partial results may be kept in sixteen bit format. If a partial result is sent to memory or another calculation unit 1200, it may be truncated into an eight-bit fixed point format as described below.

Such partial results may utilize additional bits to handle the augmented precision. Such added bits may be made to the integer part of the results. Utilizing such additional bits, 4:2 CSA 1218 and 24-bit wide adder 1220 may accumulate values that overpass the output range, and thus may cause calculation circuit 1200 to avoid losing precision in the case of overflow. In one embodiment and in the 24-bit wide adder 1220, a bit may be reserved for the sign, nine bits for the integer, and fourteen bits for the fractional part. However, any suitable format may be used, including more or less additional bits for the integer.

FIG. 13B is a more detailed illustration of 24-bit wide adder 1220, which may accept the result of convolution and dot-product operations after being passed through signal extension 1216. The result is added to temp data 1206 received from another layer determination and to a previous iteration of 24-bit wide adder 1220. Such addition may be made, for example, by 4:2 CSA 1220. The outputs of 4:2 CSA 1220 may include, for example, two outputs including a sequence of partial sum bits and a sequence of carry bits. Integer components from respective inputs may be summed in a 10-bit adder 1308 and fraction components from respective inputs may be summed in a 14-bit adder 1310. The outputs 1312, 1314 may be sent to right shifter and truncate logic 1232.

Returning to FIG. 12, in one embodiment right shifter and truncate logic 1232 may scale down the results so that they are normalized for use in a range expected by other elements, such as other calculation circuits. The values are scaled down according to scale factor 1208 used for the weights being used. Scale factor 1208 may correspond to the same scale factor used to scale the weights up. In another embodiment, right shifter and truncate logic 1232 may pare bits from the scaled down results, depending upon the destination of the data. Upper bits of the integer and lower bits of the fractional part may be discarded. In one embodiment, right shifter and truncate logic 1232 may output data in 3.7 format, with a sign bit, two integer bits, and five fraction bits. Such a format may be expected by, for example activation function 1234.

FIG. 13C is a more detailed illustration of right shifter and truncate logic 1232. Integer data 1312 (with an example 10-bit width) and fractional data 1314 (with an example 14-bit width) may be input. Fractional data 1314 may be truncated by its seven lower bits by fractional truncation 1314. 16-bit arithmetic right shifter 1318 may scale the integer and fractional data according to scale factor 1208. The output may be in 10.7 format, which in turn may be truncated by final truncation 1322 into 3.7 format for output.

Returning to FIG. 12, once a result is final it may be passed into activation function 1234. From there, it may be eventually passed as output 1244. If a result is not final, it may be written to storage, memory, or otherwise passed to another calculation circuit. Such non-final results may be output to become temp data 1206 of another calculation circuit.

Accordingly, in one embodiment an augmented, scaled-up result may be maintained within calculation circuit 1200 but may be truncated when such a result is passed out calculation circuit 1200. Weights 1204 and input data 1202, for example, might be kept in lower precision. Partial results are stored in memory so as not to lose interim precision between successive operations of different calculation circuits upon successive portions of the same layers. When used by a subsequent calculation circuit, partial results may be scaled up by 16-bit arithmetic left shifter 1240.

Control of information between different instances of multiplication circuits may be performed in any suitable manner. For example, processing device 1000 may include registers for storing weights or input values as well as multiplexers to route values to appropriate multiplication circuits. Routing of signals and coordination to effect operation of CNN 900 may be performed by, for example, distribution logic 1116 and 1122.

To illustrate the effects and operation of calculation circuit 1200, consider the following possible input matrix:

TABLE 1
Example Input Matrix

| | |
|---|---|
| 128 | 16 |
| 32 | 24 |

Furthermore, consider the following example weights for a filter, determined at a full precision of seven digits. Note that the following example is made using base-ten values, but in one embodiment calculation circuit 1200 may operate to perform such operations in base-two.

TABLE 2
Example Full-Precision Filter

| | |
|---|---|
| 0.0005672 | 0.0012342 |
| 0.0023813 | 0.0000291 |

Such a filter, when applied to the example input, has a convolution result of 0.1704128. This is a baseline measurement to compare other results. Use of a larger number of digits or bits to calculate convolution may include additional power consumption as well as larger processor resources. If the architecture to compute the convolution result is limited to less digits of precision, the extra precision created by using the original seven-digit observations may be negatively affected. For example, consider the same filter if limited to four digits of precision, assuming that the architecture for calculating convolution is limited as such:

TABLE 3
Example 4-Digit-Precision Filter

| | |
|---|---|
| 0.0005 | 0.0012 |
| 0.0023 | 0.0000 |

Such a filter, when applied to the example input, may have a convolution result of 0.1568, which has an error of 7.988% when compared to the baseline calculation. The error is attributable to the loss in precision in the weights of the filter limited to four digits of precision.

As described above, in one embodiment the same four digits of precision may be used by shifting the data left and truncating any extra bits. The shifting may be made so as to expand the weights to as close to “1” as possible within the base-10 (or base-2) shifting scheme. The number of digits shifted is stored and used to scale back the result. For example, consider the full-precision contents of Table 2 as shifted and truncated and presented below as a weight-shifted filter:

TABLE 4
Example 4-Digit-Precision, Weight-Shifted Filter

| | |
|---|---|
| 0.0567 | 0.1234 |
| 0.2381 | 0.0029 |

As discussed above, in one embodiment the number of digits or bits shifted may be held constant for all weights within a given layer, even though some weight values might yet be shifted again. For example, “0.2381” cannot be shifted again without exceeding the example boundary of [−1, 1], though “0.0029” could be shifted again two more times. Accordingly, in such an embodiment some weights might still include leading zeroes.

Such a filter, when applied to the example input by calculation circuit 1200, would have an unadjusted convolution result of 17.0368. Such a result would be subsequently shifted back to the right by calculation circuit 1200 and truncated. For example, the convolution result may be 0.1703. This result may have an error of 0.066%.

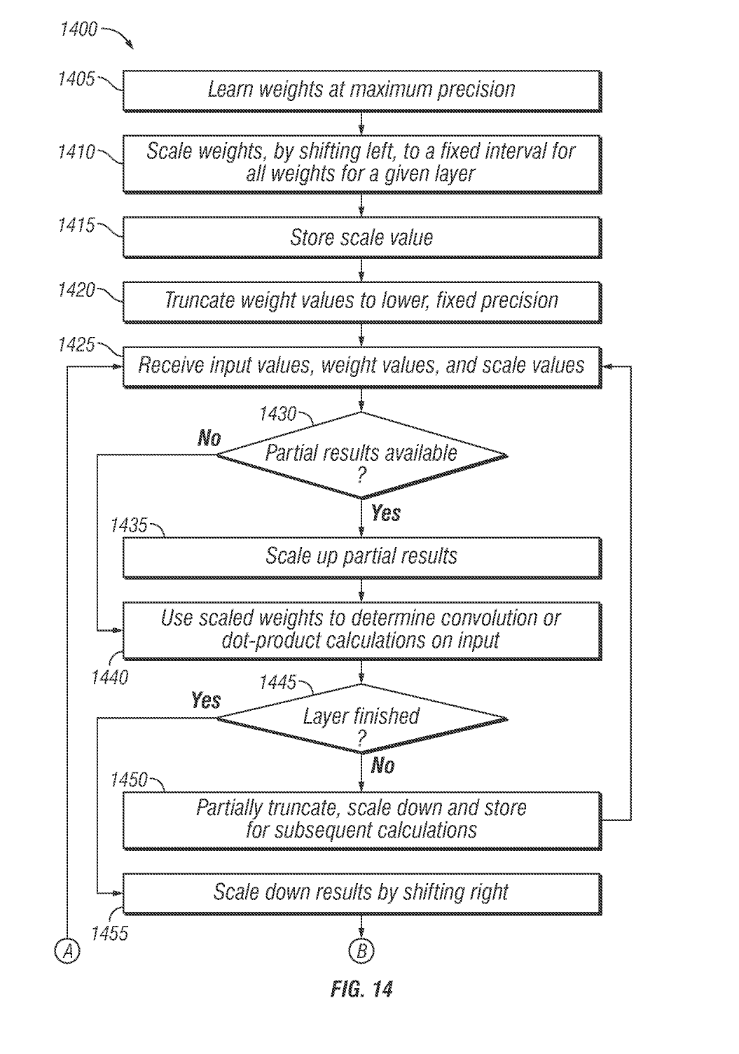

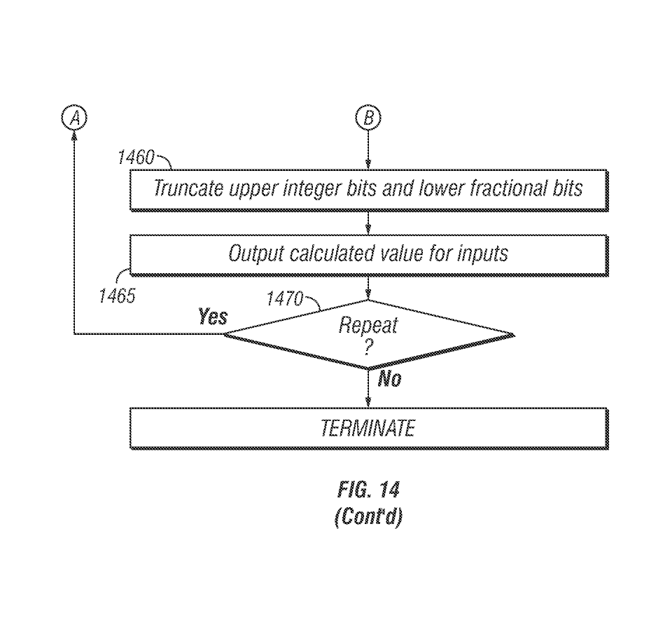

FIG. 14 is a flowchart of an example embodiment of a method 1400 for weight-shifting, in accordance with embodiments of the present disclosure. Method 1400 may illustrate operations performed by, for example, CNN 900, processing device 1000, or calculation circuit 1200. Method 1400 may begin at any suitable point and may execute in any suitable order. In one embodiment, method 1400 may begin at 1405.

At 1405, weights to be applied to a CNN may be learned. In one embodiment, such weights may be learned with a maximum number of digits of precision. At 1410, such weights may be scaled to a fixed interval. In one embodiment, such scaling may be made by shifting values of the weights left until the weights best fit within the fixed interval. In another embodiment, the same shifting may be applied for all weights of a given layer, even if additional shifting would benefit some of the weights but cause still others to exceed to the fixed interval.

At 1415, in one embodiment a scaling factor specifying how much the weights were shifted or scaled may be stored. At 1420, the weight values may be truncated to fit a fixed representation of lower precisions.

In one embodiment, 1405-1420 may be performed offline or before convolution, dot-product, filtering, or other calculations or operations are to be performed on data such as images. 1405-1420 may be performed by, for example, processing units. In another embodiment, 1425-1465 may be performed repeatedly for different data. 1425-1465 may be performed by, for example, calculation circuits and coordinated by processing units.

At 1425, input values and weight values may be received. Furthermore, scale values indicating the degree to which the weights were scaled may be received. The input values and weight values may be of a fixed size and of a lower precision than which the weight values were originally determined.

At 1430, it may be determined whether partial results, previously determined by a calculation circuit working on the same layer, are available. If such partial results are available, in one embodiment the partial results may be scaled up in precision by shifting left according to the determined scale factors. If not, method 1400 may proceed to 1440.

At 1440, the scaled weights may be used to determine suitable calculations, such as convolution or dot-product, on the input. The previous results may also be used, if available.

At 1445, in one embodiment it may be determined whether computations have finished for the layer. If not, method 1400 may proceed to 1450. If so, method 1400 may proceed to 1455.

At 1450, partial results may be stored for future computation on the same layer. In one embodiment, if such results are to be performed on the same calculation circuit then the results may be stored in a latch in the calculation circuit. In another embodiment, if such results are to be performed on a different calculation circuit then the results may be partially truncated. Furthermore, the results may be scaled down by, for example, shifting their values right by the scaling factor. The truncated and scaled results may be stored in memory, a register, or otherwise sent to another calculation circuit. Method 1400 may return to 1425.

At 1455, in one embodiment the results may be scaled down. The results may be scaled down by, for example, shifting right by a number of bits or digits corresponding to the scaling factor. At 1460, in another embodiment the results may be truncated. For example, the upper integer bits and lower fractional bits may be truncated according to an expected output format. At 1465, the result may be output as the determined calculated value associated with the layer.

At 1470, it may be determined whether to repeat with, for example, additional input values for another layer. If so, method 1400 may return to 1425. Otherwise, method 1400 may terminate.

Method 1400 may be initiated by any suitable criteria. Furthermore, although method 1400 describes an operation of particular elements, method 1400 may be performed by any suitable combination or type of elements. For example, method 1400 may be implemented by the elements illustrated in FIGS. 1-13 or any other system operable to implement method 1400. As such, the preferred initialization point for method 1400 and the order of the elements comprising method 1400 may depend on the implementation chosen. In some embodiments, some elements may be optionally omitted, reorganized, repeated, or combined. Furthermore, method 1400 may be performed fully or in part in parallel with each other.

Embodiments of the mechanisms disclosed herein may be implemented in hardware, software, firmware, or a combination of such implementation approaches. Embodiments of the disclosure may be implemented as computer programs or program code executing on programmable systems comprising at least one processor, a storage system (including volatile and non-volatile memory and/or storage elements), at least one input device, and at least one output device.

Program code may be applied to input instructions to perform the functions described herein and generate output information. The output information may be applied to one or more output devices, in known fashion. For purposes of this application, a processing system may include any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine-readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

Accordingly, embodiments of the disclosure may also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part-on and part-off processor.

Thus, techniques for performing one or more instructions according to at least one embodiment are disclosed. While certain exemplary embodiments have been described and shown in the accompanying drawings, it is to be understood that such embodiments are merely illustrative of and not restrictive on other embodiments, and that such embodiments not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor, comprising:
a processor core including:
a first logic to determine a set of weights for use in a convolutional neural network (CNN) calculation;
a second logic to scale up the weights using a scale value; and
a calculation circuit including:
a third logic to receive the scale value, the set of weights, and a set of input values, each input value and associated weight of a same fixed size;
a fourth logic to determine results from CNN calculations based upon the set of weights applied to the set of input values;
a fifth logic to scale down the results using the scale value;
a sixth logic to truncate the scaled down results to the fixed size; and
a seventh logic to communicatively couple the truncated results to an output for a layer of the CNN.

2. The processor of claim 1, wherein the processor core further includes an eighth logic to truncate the scaled up weights to the fixed size.

3. The processor of claim 1, wherein the processor core further includes an eighth logic to scale up all weights with the same scale value for a given layer of the CNN.

4. The processor of claim 1, wherein the processor core further includes an eighth logic to scale up the weights to a fixed interval of values.

5. The processor of claim 1, wherein the calculation unit further includes an eighth logic to shift bits of the results to the right in order to scale down the results, the scale value indicating the number of bits to be shifted.

6. The processor of claim 1, wherein the calculation unit further includes an eighth logic to store the scaled down results as partial results for future calculations.

7. The processor of claim 1, wherein the calculation unit further includes:
an eighth logic to receive partial results from a previous calculation;
a ninth logic to scale up the partial results using the scale factor;
a tenth logic to determine the results from CNN calculations further based upon the partial results.

8. A system, comprising:
a processor core including:
a first logic to determine a set of weights for use in a convolutional neural network (CNN) calculation;
a second logic to scale up the weights using a scale value; and
a calculation circuit including:
a third logic to receive the scale value, the set of weights, and a set of input values, each input value and associated weight of a same fixed size;
a fourth logic to determine results from CNN calculations based upon the set of weights applied to the set of input values;
a fifth logic to scale down the results using the scale value;
a sixth logic to truncate the scaled down results to the fixed size; and
a seventh logic to communicatively couple the truncated results to an output for a layer of the CNN.

9. The system of claim 8, wherein the processor core further includes an eighth logic to truncate the scaled up weights to the fixed size.

10. The system of claim 8, wherein the processor core further includes an eighth logic to scale up all weights with the same scale value for a given layer of the CNN.

11. The system of claim 8, wherein the processor core further includes an eighth logic to scale up the weights to a fixed interval of values.

12. The system of claim 8, wherein the calculation unit further includes an eighth logic to shift bits of the results to the right in order to scale down the results, the scale value indicating the number of bits to be shifted.

13. The system of claim 8, wherein the calculation unit further includes an eighth logic to store the scaled down results as partial results for future calculations.

14. The system of claim 8, wherein the calculation unit further includes:
an eighth logic to receive partial results from a previous calculation;
a ninth logic to scale up the partial results using the scale factor;
a tenth logic to determine the results from CNN calculations further based upon the partial results.

15. A method for security, comprising:
determining a set of weights for use in a convolutional neural network (CNN) calculation;
scaling up the weights using a scale value and routing the weights to a calculation circuit;
receiving the scale value, the set of weights, and a set of input values at the calculation circuit, each input value and associated weight of a same fixed size;
determining results from CNN calculations based upon the set of weights applied to the set of input values;
scaling down the results using the scale value;
truncating the scaled down results to the fixed size; and
communicatively coupling the truncated results to an output for a layer of the CNN.

16. The method of claim 15, further comprising truncating the scaled up weights to the fixed size.

17. The method of claim 15, further comprising scaling up all weights with the same scale value for a given layer of the CNN.

18. The method of claim 15, further comprising scaling up the weights to a fixed interval of values.

19. The method of claim 15, further comprising shifting bits of the results to the right in order to scale down the results, the scale value indicating the number of bits to be shifted.

20. The method of claim 15, further comprising:
receiving partial results from a previous calculation;
scaling up the partial results using the scale factor;
determining the results from CNN calculations further based upon the partial results.
